(19) United States
(12) Patent Application Publication
(10) Pub. No.: US 2024/0183714 A1
(43) Pub. Date: Jun. 6, 2024

(54) OPTICAL FREQUENCY SENSORS BASED ON PRE-MODULATED QUADRATURE-SELF-HETERODYNE INTEFEROMETRY

(71) Applicant: Technion Research & Development Foundation Limited, Haifa (IL)

(72) Inventors: Moshe Nazarathy, Haifa (IL); Anna Kodanev, Haifa (IL)

(73) Assignee: Technion Research & Development Foundation Limited, Haifa (IL)

(21) Appl. No.: 18/527,210

(22) Filed: Dec. 1, 2023

Related U.S. Application Data
(60) Provisional application No. 63/385,763, filed on Dec. 1, 2022.

(51) Int. Cl. G01J 3/45; G01J 3/32

(52) U.S. Cl. CPC G01J 3/45; G01J 3/32; G01J 2003/283

(57) ABSTRACT

An optical frequency sensor that includes (i) a heterodyne modulation and splitting unit that is configured to receive a first laser signal, modulate the first laser signal to provide a modulated laser signal and split the modulated laser signal to provide pre-processed optical signals; (ii) a self-coherent interferometer that includes (ii.1) a first optical processor that is configured to process the pre-processed optical signals to provide processed optical signals, and (ii.2) a detection unit that is configured to electro-optically mix the processed optical signals and photodetect an outcome of the mixing to provide detection signalsm and (iii) a signal processor configured to process the one or more digital signals to provide digital information about the first laser signal.

### CROSS REFERENCE

This application claims priority from U.S. provisional patent Ser. No. 63/284,549 filing date Dec. 1, 2022, which is incorporated herein by reference.

### BACKGROUND

Optical communication networks are very popular as they are capable of conveying vast amounts of traffic.

When operating at very high frequencies there is an accute need for highly accurate receivers.

### BRIEF DESCRIPTION OF THE DRAWINGS

The embodiments of the disclosure will be understood and appreciated more fully from the following detailed description, taken in conjunction with the drawings in which:

FIG. 1 illustrates an example of an Optical Frequency Sensors (OFS);

FIG. 2 illustrates an example of a Resonator-based OFS;

FIG. 3 illustrates an example of a Delay Interferometer (DI) based OFS;

FIG. 4 illustrates an example of a discrete-optics free-space implementation of DI-based OFS;

FIG. 5 illustrates an example of an augmentation of the ‘interferometric dual-track’ by inserting in at least one of the s- and r-paths slow phase modulators (PM) and/or amplitude modulators (AM), for extremum seeking control purposes;

FIG. 6 illustrates an example of a signal processor;

FIG. 7 illustrates an example of a signal processor;

FIG. 8 illustrates an example of a prior art LASER LOCKING;

FIG. 9 illustrates an example of a OFS-based sideband-offset laser locking loop with continual frequency tuning;

FIG. 10 illustrates an example of a Optical Mutual Frequency Sensor (OMFS), sensing mutual Frequency-Deviation (FD) and optionally the mutual RIN of a pair of CW lasers;

FIG. 11 illustrates an example of A Tunable offset sideband locking of a pair of lasers;

FIG. 12 illustrates examples of detection units;

FIG. 13 illustrates examples of intermefometric dual tracks;

FIG. 14 illustrates an example of a method;

FIG. 15 illustrates an example of a method;

FIG. 16 illustrates an example of a method;

FIG. 17 illustrates an example of a method;

FIG. 18 illustrates an example of a demodulator (DEMOD) bank;

FIG. 19 illustrates an example of a slow-variable 1:2 splitter implemented as slow Mach-Zehnder-Modulator (MZM);

FIG. 20 illustrates an example of a Derotation (DEROT) bank;

FIG. 21 illustrates an example of an implementation of a complex derotation unit for order[±n] subcarriers;

FIG. 22 illustrates an example of an IQ-imbalance compensation bank unit of the signal processor

FIG. 23 illustrates an example of an Graphic representation of the WL-ellipse formation and its compensation;

FIG. 24 illustrates an example of an FD&RIN est' module of the Signal Processor top-level block diagram of FIG. 6;

FIG. 25 illustrates an example of an optical delay locked loop for Differential Group Delay (DGD) estimation and compensation, used in conjunction with our DI-based OFS (the preMOD QDSH), acting to actuate the dither frequency inversely to the fluctuations of the DGD such that to counteract them;

FIG. 26 illustrates an example of an OFS that has a modulation unit that includes a dual-output push-pull;

FIG. 27 illustrates examples of modulation units of an OFS;

FIG. 28 illustrates examples of single input single output modulators that are either a part of the OFS or precede the OFS;

FIG. 29 illustrates examples of OFSs;

FIG. 30 illustrates an example of a spectral picture of the offset sideband locking, assuming it is the sideband order[−2] that is locked to the cavity anti-resonance; and

FIG. 31 illustrates an example of sub-harmonic carrires and a carier frequency.

### DETAILED DESCRIPTION OF THE DRAWINGS

This solution addresses Interferometric Optical Frequency Sensors (OFS) based on self-coherent optical detection. Sample potential applications of the disclosed OFS include measurement systems for laser source characterization, laser spectral stabilization systems for spectroscopy, communication, metrology, and sensing various physical variables encoded as optical frequency deviations. The solution scope is restricted to self-coherent two-beam interferometric structures.

‘Self-coherent’ means here that the Differential Group Delay (DGD) spread between the two paths in the interferometer is (much) smaller than the coherence time of the optical source(s), i.e., the beams arrive at the photo-detector(s) with high mutual coherence. A characteristic shared by all our disclosed OFS systems is their use of Heterodyne (self-)coherent detection, terminating the opto-electronic interferometric section of the OFS in single quadrature or dual quadrature optical hybrids followed by electrical demodulations and additional signal processing.

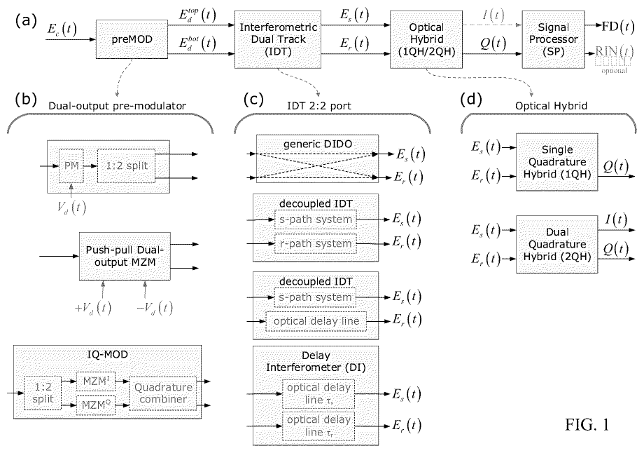

Our disclosed OFS systems are distinguished by inventive opto-electronic structures and methods referred to here as ‘pre-Modulated (preMOD Quadrature-Self-Heterodyne’ (preMOD-QSH) in conjunction with the optical hybrids. In essence, our OFS systems are based on heterodyne coherent detection of the optical beat between two beams which were amplitude-split from a single optical source, which feature phase (and frequency) and power fluctuations (and possibly also deterministically phase/frequency modulations) to be sensed, discerned by the following unique ingredients (FIG. 1).
(a) heterodyne pre-modulation (preMOD) ahead of the interferometric device (rather than modulation inserted within the interferometer, typically asymmetrically in one arm, as in prior-art). The term ‘heterodyne interferometry’ describes two-beam interference when one of them is shifted to a new frequency range.

Our sinusoidal dithering preMOD generalizes heterodyne interferometry by shifting both beams to diverse frequency ranges. Moreover, it is twice as efficient in modulation index (relative to placing the dither modulator in one interferometer arm) and it induces a useful frequency dependency of the interferometric response, which enables innovative sensing of real-time DGD fluctuations. It also cancels common mode low frequency noise which equally affects both paths.
(b) use of a single or dual-quadrature optical hybrid for self-coherent detection.
(c) signal processing applied on the hybrid electrical output(s).

There is provided a family of OFS systems of the preModulated Quadrature-Self-Heterodyne (prcMOD-QSH) type, namely heterodyne two-beam interferometers with all three characteristics (a), (b), (c) listed above.

Those are some embodiments.

More generally we disclose OFS systems satisfying the characteristic (b), (c) above, with the heterodyne dither modulation performed by either a SISO modulator in one of the interferometer arms, or by a dual-output pre-modulator as in (a).

Note: The term ‘heterodyne interferometer’ is double-entendre, pertaining on one hand to prior-art on the Delay-Self-Heterodyne systems as well as to our solution , but on the other hand referring to a specific sub-family of interferometers with moving mirrors, inducing frequency shift in one of the arms by the Doppler effect. It is possible to have our disclosed elements (a), (b), (c) jointly applied to such moving parts interferometers but we do not elaborate on it.

None of our OFS disclosures here have moving parts.

The gist of (a) above is that, structurally, the disclosed OFS structures pre-modulate the incoming beam prior to having it split and propagated through the interferometric dual-path structure. Functionally, both beams become multi-tone optical signals. The difference between the two spectral structures is essential. The term ‘pre-’, in our ‘pre-modulation’, qualifier, highlights the distinction with respect to prior-art. The pre-modulated pair of beams then propagates through the ‘interferometric dual-track’—our term for the optical structure wherein the two light beams propagate along two respective (typically asymmetric and typically uncoupled) optical systems, referred to as the ‘s-path’ and ‘r-path’. For the pre-modulator (preMOD) we most generally disclose harmonic-multitone-driven dual-output modulation structure being placed ahead of the interferometric dual-track structure, in contrast with prior-art which has a sinusoidally-driven optical modulator inserted into just one of the two propagation paths of the interferometric dual track. In our inventive step we ‘pre-’position the modulator ahead of the interferometric dual-track structure and have the pre-modulator provisioned with dual outputs to provide a pair of either identically or differently modulated optical signals to the two input beams into the interferometric structure. The dual-output pre-modulator ‘black-box’ internally consists of either a single optical modulator split two-way, or a compound modulator with two outputs such as an MZM or an IQ-modulator wherein the conjugate port is also used.

The deterministic pair of modulations emitted by dual-output pre-modulator are generated by driving it by multitone RF signal(s), sinusoidal signals as a special case (where by ‘multitone’ we mean a sum of sinusoidal waveforms of various frequencies, which are harmonically or non-harmonically related). The gist of (b) above is that two output beams emerging from the interferometric dual-track structure are finally electro-optically mixed and photodetected by means of either a single-quadrature or dual-quadrature optical hybrid. The dual-output optical pre-modulation ahead of the ‘interferometric dual-track’ is meant to cause the pair of coherently detected beams to be relatively shifted in frequency, in at least some of their optical frequency components, which get spectrally shifted away from the optical carrier(s), implying that various modulated beat-tones are going to be generated in the optical hybrid, which mixes the optical signals arriving on the s- and r-paths. Thus, coherent heterodyne processing (starting with demodulations) is needed in the receiver to extract the baseband components which have been bandpass converted by the modulation. It is the baseband components (referred to as ‘baseband sufficient statistics’) that carry salient information about the instantaneous optical ‘Frequency Deviation’ (FD) of the incoming beam (relative to the nominal spectral reference point of the optical carrier) and optionally about the Relative Intensity Noise induced optical field amplitude fluctuations (in brief referred to as RIN although this is an amplitude).

In our top-level solution (FIG. 1A), the four generic blocks or modules corresponding to criteria (i)-(v) further below, namely the dual-output-preMOD, the dual-track interferometric structure, the Optical Hybrid and the Signal Processor, are sequentially cascaded as depicted in the figure, starting from the LHS where the incoming beam from the optical source is entering our disclosed OFS system and ending on the RHS, where the Signal Processor generates electrical signals encoding estimates of the FD and RIN and possibly other output signals designating the characteristics of the incoming beam.

This generic structure breaks out into multiple embodiments and sub-embodiments, based on various disclosed options for the internals of the four modules in (FIG. 1, sections (b)-(d)), featuring various characteristics and performance tradeoffs, generally improving the instantaneous optical Frequency Deviation sensing capabilities of our disclosed OFS systems.

Throughout, ‘N:M’ denotes an N-Input to M-Output MIMO optical port. We shall also use the abbreviations SISO, SIDO, DIDO (S=Single, D=Dual) for the 1:1, 1:2, 2:2 optical ports, respectively.

Once we exhaust the treatment of OFS, we disclose a generalization of the OFS, referred to here as Optical Mutual Frequency Sensor (OMFS), for sensing the mutual-FD and mutual-RIN of a pair of beams. The OMFS is a generalization of the OFS and evidently does not conform with the OFS structure and block diagram. However, the bulk of our embodiments pertains to the OFS. The family of multiple disclosed OFS embodiments may be classified into sub-families of embodiments per the following criteria, cach branching into sub-embodiments pertaining to the various constituents of the OFS end-to-end chain:
criterion (i): Fast dual-output pre-Modulation (preMOD) electro-optic module (FIG. 1 section (b)), and its
   RF multitone drives (dithering MOD, driven by sinusoidal tone(s) or proper multitone signals).

### Sub-Embodiments

(i-a) ‘prePM’: an optical Phase Modulator (PM) followed by a 1:2 splitter (fixed 50-50 directional coupler or variable splitter ('var1:2split′) such as a slow dual-output Mach-Zehnder-Modulator set for a particular splitting ratio).
(i-b) ‘pre-MZM: Dual-output Mach-Zehnder Modulator (MZM) with its top and bottom branches being push-pull (differentially) driven by a multitone (or sinusoidal) RF drive signal.
(i-c) IQ-MOD (typically IQ-MZM) with its with its two ‘children’ amplitude MODs 2:1-combined into a single output, two-way split by means of a fixed or variable 1:2 splitter (1:2 or var1:2 respectively).
(i-d) IQ-MOD with its two ‘children’ amplitude modulators combined in quadrature by a 2:2 (fixed, such as a 50-50 directional coupler or variable, such as a slow Mach-Zehnder-Modulator).

The advantages of our preMOD based disclosed electro-optic structure for the DI are (a) higher resilience of the system to impairments of the PM or FM. (b) lower drive power (by a factor of four) and half the drive voltage (half the modulation index) required to modulate our PM pre-mod in our DI based OFS, to the same net modulation depth as a conventional DI-based Delayed Self Heterodyne (DHS) system. (c) ability to operate the IQH-heterodyne DI scheme in a destructive interference mode of the dithering phase (the peak amplitude response of which is generally dependent on the dither frequency in the preMOD scheme), to enable unique DGD sensing capability, disclosed in (iv-e) below. Having the sinusoidally-dithered-PM precede the DI splitter, as we have proposed here, enables obtaining a higher quality signal at the IQH output.
criterion (ii): The optical HYBRID used for self-coherent detection (for electro-optically mixing the two beams emerging out of the s- and r-paths) (see FIG. 1, section (d)):
(ii-a) Single-Quadrature optical Hybrid (1QH). A DISO system with two optical inputs and one electrical output (the ‘single’ quadrature customarily denoted as Q(t)).
(ii-b) Dual-Quadrature optical Hybrid (2QH) aka IQ-hybrid (IQH). A DIDO system with two optical inputs and a pair of electrical outputs (the two ‘quadratures’, customarily denoted as I(t) and Q(t)).

The case of ‘2:1 combiner+single-ended-PD’, i.e., a single PhotoDetector (PD) features prominently in prior-art interferometers, as it is the conventional termination of most two-beams interferometers. This case may also be considered for as a variant of those of our embodiments that use the 1QH (i.e., the 1QH may be replaced by a ‘2:1 combiner+single-ended-PD’, but such variant embodiments are

non-preferred, as their performance is inferior to that of case (ii-a).
criterion (iii): The ‘INTERFEROMETRIC DUAL-TRACK’ (IDT), (see FIG. 1C): defined here as 2:2 (DIDO) passive optical system via which the two input beams propagate to two optical output ports.

Note: The IDT may be identified as the core constituent of any two-beam interferometer. The IDT should be preceded by means to amplitude-split the input beam to feed the input ports of the IDT (in our disclosed OFS that is the preMOD). It should be followed by the means to combine the two beams at the IDT output ports (in our disclosed OFS it is the optical hybrid that performs the optical combining of the two IDT outputs, see criterion (ii)). It is the cascade of the 1:2 splitting means, the IDT and the combining means that forms any complete two-beam interferometer.

The DIDO system constituting the IDT may be described by a 2×2 MIMO matrix with all four elements being non-zero, i.e., any of the two input ports is coupled to any of the two output ports. Our OFS may typically function with any IDT, including those with non-zero cross-diagonal elements in their MIMO matrix. However, most of our disclosed embodiments are based on a sub-family of the IDT referred to as ‘decoupled IDTs’, defined as IDTs with null off-diagonal matrix elements in their 2×2 MIMO matrices. Our main interest is in OFS systems comprising ‘decoupled IDTs’, consisting of two SISO optical systems in parallel, referred to as the ‘s-path (system)’ and the ‘r-path (system)’. The respective I/O ports to these two path-systems are referred to as the s-input, r-input and s-output, r-output. See FIG. 1c for the various sub-embodiments of the IDT, down from the most general to the most particular:
(iii-a) The two uncoupled s- and r-paths consist of a pair of passive frequency-selective optical systems (possibly in cascade with optical delay line(s), possibly interconnecting the SISO systems to their respective s- and r-I/O optical ports), typically asymmetric, i.e. the two s-path and r-path SISO systems are not identical.
(iii-b) The s-path may include a passive frequency-selective optical system (possibly in cascade with one or two optical delay lines interconnecting it to the s-input and s-output of the interferometric structure), whereas the r-path merely consists of an optical delay line.
(iii-c) A particular sub-embodiment specifies for the ‘passive frequency-selective optical system’ in the s-path to an optical resonator, whereas the r-track is a short optical delay line. A complete OFS based on such resonator-based IDT, as depicted in FIG. 2 referred to in our terminology as Pre-Modulated Quadrature Resonant Self Heterodyne (preMOD QRSH).
(iii-d) DI-IDT: Both s- and r-paths consist of optical delay lines, albeit having different optical lengths (typically the r-path is shorter). This IDT sub-embodiment is referred to as DI-IDT, where DI stands for optical Delay Interferometer. Note: Beware that conventionally the term DI is meant to describe the cascade of passive means to split the input beam 2-way, an IDT just as described here, consisting of two unequal length delay lines, and the means to combine and photo-detect the two DI-IDT outputs (typically by a 2:1 combiner feeding a single-ended Photodetector (PD) in prior-art, though hybrid-based combiners have also been disclosed.

The optical realizations of the DI may be diverse. A DI in the conventional sense is any two-beam interferometer in which the input CW light split from the laser propagates along two asymmetric paths consisting of two optical delay lines of different lengths. In our topological description, a DI consists of the means to split the light (in the simplest case a 1:2), an IDT comprising two asymmetric optical delay lines (as in (iii-d) above) and the means to combine and photo-detect the light (in the simplest case a 2:1 terminated by a Photodetector (PD), and in our embodiments a 1QH or 2QH hybrid). The two optical delay lines of the DI-IDT sections may be implemented either as optical waveguides, optical fibers or discrete-optics structures for free-space beam propagation paths possibly with reflections/refractions to change the beam directions. The two optical delay lines in the DI-IDT should have, by definition, different optical lengths (this is the meaning of ‘asymmetric’).

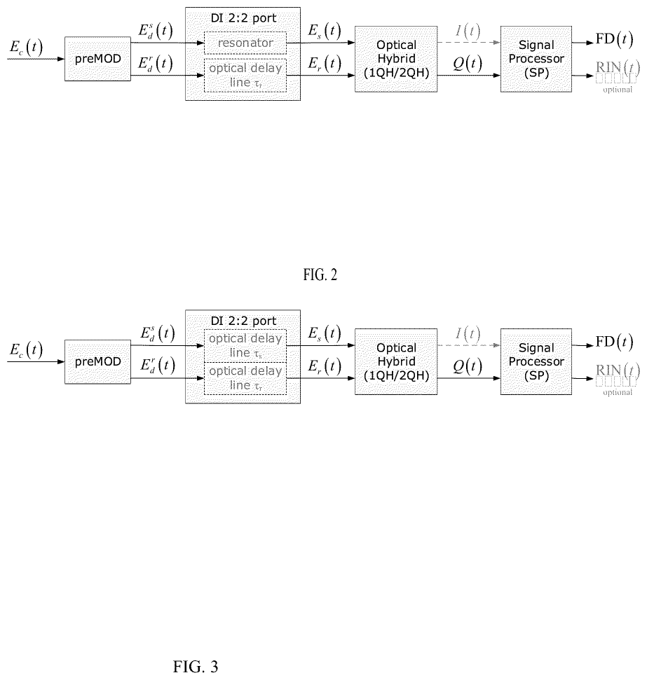

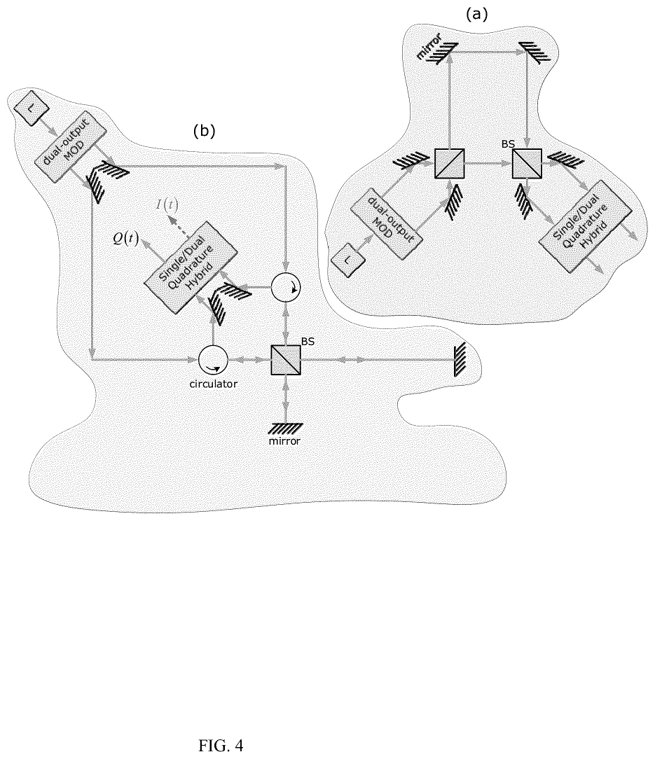

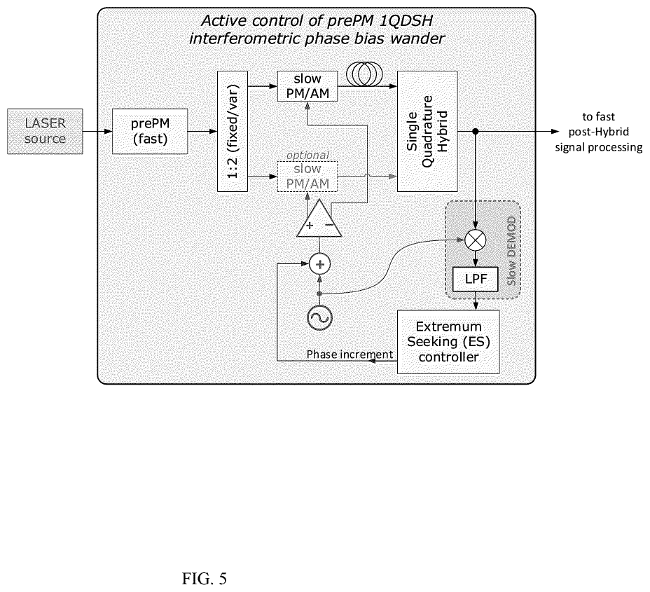

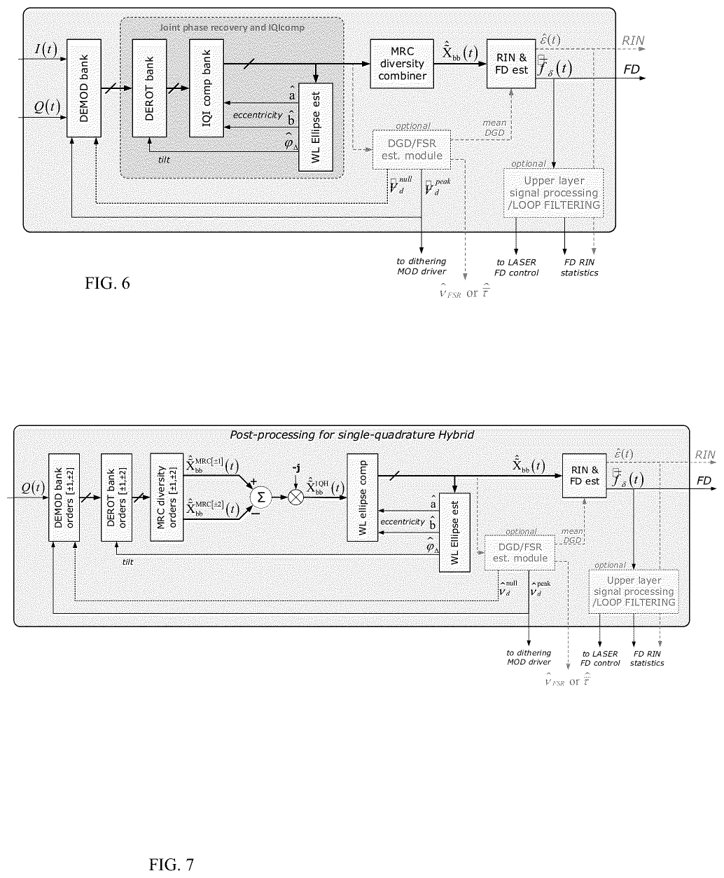

A complete OFS based on such DI-IDT (FIG. 3) is referred to in our terminology as Pre-Modulated Quadrature Delay Self-Heterodyne (preMOD QDSH). This system consists of our dual-output preMOD, followed by the DI-IDT comprising the two parallel optical delay lines, the s- and r-outputs of which are electro-optically combined by a 1QH or preferably a 2QH optical hybrid, terminated in the Signal Processor (SP). FIG. 4 discloses two variants of free-space DIs—the Michelson Interferometer (MI) and the Mach-Zehder Interferometer (MZI), converted into structures suitable for implementing our preMOD QRSH OFS, by having them retrofitted with a preMOD and an optical Hybrid (which may require collecting beam(s) that are usually discarded). Similar opto-electronic MI and MZI variants have appeared in prior art of high-end free-space interferometry but just at the output side of the DI (i.e., balanced-PD was used [1 ], equivalent to our single-quadrature hybrid). Our disclosed systems in FIG. 4 differ from conventional MI and MZI DIs, in that both ports of the input beam-splitter are fed by modulated light beams (rather than a single port of the beam-splitter being fed), and also both outputs of the output beam-splitter are collected to be processed by an optical hybrid). For high-end interferometric applications requiring FD readout, it is beneficial to adopt such free-space-based preMOD QRSH interferometers (and have them enabled by our disclosed SP) order to transcend the current operational limits.
(iii-e) Optional augmentation of the OFS in either of the sub-embodiments iii-a to iii-d above, by inserting in at least one of the s- and r-paths slow phase (PM) and/or amplitude (AM, e.g., MZM) modulators (FIG. 5), for calibration and tracking purposes. Insertion of the slow modulation means within the IDT, is performed in tandem with the sub-systems already present in the two paths, these slow phase modulators being driven by slow baseband signals and by slow, weak dithering multitone signals, (not to be confused with the fast dithering modulating signals(s) driving our preMOD, consisting of high frequency RF multitone signals). These low-frequency phase modulations induce phase dithering perturbations and phase actuation for bias wander pre-calibration and tracking control. To this end, our preferred methodology to use is extremum-seeking control. Such slow phase (or amplitude, MZM-based) actuators may be inserted not only in the IDT but within the preMOD or within the optical hybrid. This augmentation by slow modulators is optionally used. The slow, weak active modulations are accompanied by corresponding signal processing functions in the SIGNAL PROCESSOR (sec (iv) below), by incorporating an extremum-seeking signal processing module to estimate the low-frequency differential phase wander between the s- and r-paths, while using the aforementioned slow, weak optical dithering modulations applied to the additional phase modulators and actuating control phase increments onto these slow modulators. Note: Augmentation by slow modulators is unnecessary for OFS based on the 2QH type of hybrid, and it is optional for the 1QH type of hybrid, note that equivalent functionality may be innovatively attained in signal processing more efficiently for 2QH than 1QH, thus the usage of these slow phase modulators is optional.
(iii-f) Optical coherent heterodyne OFS, splitting light passively two-way to the input s- and r-ports of the DIDO ‘interferometer dual track’, which now comprises a pair of optical passive systems, at least one of which is in tandem with a dithering modulator (where by dithering modulator we mean a modulator driven by a sinusoidal or multitone RF signal), with the output s- and r-ports of the ‘interferometric dual port’ feeding into means to combine and photo-detect the light consisting of either a single-quadrature optical hybrid or a dual-quadrature-optical hybrid, followed by electronic signal processing to extract sensing information. Note: In this criterion we do not include the pre-MOD but we rather use one or two intra-interferometric-MODs (meaning modulators inserted within the interferometer), but we should have single- or dual-quadrature optical detection and appropriate signal post-processing to extract the sensing information.
criterion (iv): The structure and functionality of post-detection electrical analog and/or digital SIGNAL PROCESSOR (SP) processing onto the electrical output signal(s) of the optical Hybrid (see FIG. 6 for the SP in the case of 2QH hybrid and FIG. 7 for the SP in the case of 1QH hybrid). This signal processing is essential to ensure proper operation and attain certain capabilities and end-to-end performance improvements for the OFS. Under this criterion, we disclose a suite of signal processing modules, and their interconnections as building blocks within our SP sub-systems,
(iv-a) complex demodulation (DEMOD) bank and derotation (DEROT) bank, to extract and down-convert to based sensing information carried by the individual complex harmonic subcarriers within the IQ or single quadrature electrical signal(s) received at the Hybrid output(s).
(iv-b) analog or digital coherent combining aka Maximal Ratio Combining (MRC) of redundant multiple demodulated signals for improvement of the Signal-to-Noise Ratio (SNR).
(iv-c) estimation and mitigation of the IQ-imbalance (in the ‘IQ-comp’ and ‘WL-ellipse est’ modules) of the optical hybrid and estimation of the arrival phases (which are passed to the demodulation bank for optimal performance). Note: IQ-imbalance turns out to be a major impairment in heterodyne OFS systems at large and in our SP, in particular, hence its robust estimation and compensation are important.
(iv-d) Decoupled extractions of the FD fluctuations, decoupling the FD fluctuations from the RIN fluctuations, for successful sensing of both quantities in parallel or either at them on its own (note: the extraction of the RIN-term optional in some laser characterization systems, while it is not generally necessary in laser stabilization/locking systems, which just use the FD as error signal for tuning the laser frequency).

In case that the 2QH hybrid is used (as per (ii-b) above) our disclosed extraction of the FD and RIN terms (essentially without mutual coupling) is entirely conducted in the SP, based on estimation-and-compensation of the low-frequency differential phase wander between the s- and r-paths, which may be realized by a digital PLL realized within the SP module (iv-c). In case that a 1QH hybrid is used (as per (ii-a) above), the decoupling of the FD and RIN terms may also be based on entirely conducted in the SP. Optionally we may attain the same functionality by using active slow dithering and actuating modulations and extremum-seeking control, as per (iii-e) above.
(iv-e) estimation of the instantaneous Differential Group Delay (DGD), t, between the s- and r-paths and mitigation of the fluctuations of the DGD for our DI-based OFS, provided a low-phase-noise tunable RF oscillator (VTO or synthesizer) is available to actuate the sinusoidal dither frequency. This DGD sensing and compensation capability is unique—it is structurally enabled by having adopted the preMOD (inserted ahead of the DI) for dithering. The preMOD and the hybrid jointly impart frequency-selective response, yielding constructive/destructive interference of the phase modulations on the s- and r-paths of the IDT. For our DI-based OFS, the said interference depends on the dither frequency modulo the Free-Spectral-Range (FSR=1/τ). Selecting the dithering frequency for nominally destructive interference of the phase modulations, fluctuations of the DGD then induce proportional small amplitude fluctuations around the null response point. These fluctuations are indicative of the real-time DGD fluctuations. The accuracy of this innovative methodology hinges on the spectral purity of the dithering tone. This method is effective in mitigating the DGD fluctuations, which are yet another source of impairment for these OFS systems (in addition to the fluctuations in the differential phase bias of the interferometer, which is also an optical path fluctuation, albeit on a finer scale).
(iv-e) Our disclosure teaches heterodyne OFS with both single-quadrature (1QH) and dual-quadrature (2QH). Our analysis shows that when 1QH is used, despite giving up on one quadrature, the full information is still available in the single detected quadrature, as needed to estimate and mitigate the interferometric differential bias phase wander, ψ_{Δ}^{c}(t), and to extract the FD and RIN information. A suitable Signal Processor (SP) structure is then disclosed for the 1QH case, such that no active bias phase compensation is needed in the electro-optical domain ahead of the 1QH, yielding a robust preMOD single-Quadrature Delayed Self Heterodyne (pre-MOD IQSH) OFS which is not affected by interferometric fading, despite having no active differential optical phase bias control. The compensation of ψ_{Δ}^{c}(t) is entirely performed in the SP.
criterion (v): SYSTEM APPLICATIONS and EXTENSION SYSTEMS based on our disclosed OFS.

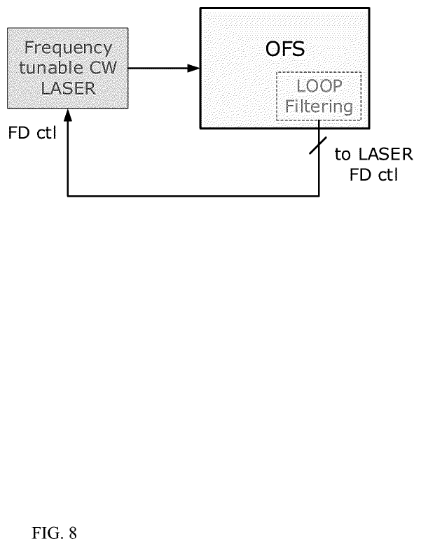

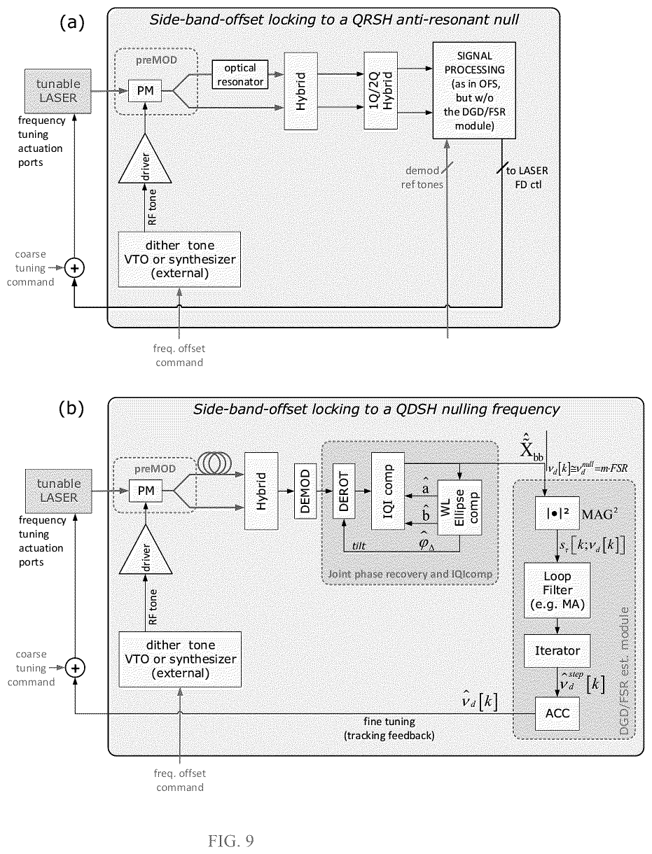

Under this criterion we list several disclosures based on or inspired by the OFS:
(v-a) Laser characterization/measurement systems. The extra signal processing of the raw FD(t) waveform provided by our OFS (and optionally the RIN-related amplitude fluctuations) is prior art. As the FD and RIN waveforms are generated at the output of our SIGNAL PROCESSOR, these waveforms may be further processed to extract statistical information on the FD, RIN, mutual statistical information on their correlations, such as the (Cross-)Power Spectral Density (X)PSD of these quantities or extract derived quantities such as the amplitude fluctuations of the laser optical field and its phase noise and some of their characteristics (e.g., the PSD of the laser optical field is the ‘laser lineshape’ and its bandwidth is the ‘laser linewidth’). Such higher-layer processing functionality is not directly addressed in this invention, as it is based on prior-art statistical processing techniques, but we have provided within our SP (FIG. 6 and FIG. 7) for the module named ‘Upper Layer Signal Processing/Loop Filter’ to have the ancillary information generated, per prior art principles, by processing our OFS generated raw FS/RIN readings.
(v-b) LASER LOCKING (stabilization) systems. Most of this functionality is known prior-art (FIG. 8), essentially an optical FLL (Frequency Locked Loop) (often misnamed as Phase Locked Loop (PLL)), wherein an OFS acts as a frequency detector/discriminator sub-system (which is essential for determining the error between the commanded and actual FD for the purpose of realizing the closed-loop control system).

Our disclosed OFS embodiments are evidently suitable as well for acting as frequency discriminators in an optical FLL/PLL for laser locking, as well (FIG. 8).The waveform FD(t) output of the OFS provides the FLL error signal (between the commanded and actual FD), fed to a loop filter to actuate the actuation input of a laser tuning means. Since the OFS is a critical clement in the loop, prior-art laser locking systems may benefit from adopting our OFS embodiments invention (having their frequency sensor replaced by our OFS, since our specifications are generally improved w.r.t. prior art OFS). We have provided within our SP (FIGS. 6 and 7) an optional module named ‘Upper Layer Signal Processing/Loop Filter’ to host FLL/PLL prior art functionality, mainly the loop filter (in parallel with optional laser 6 characterization signal processing functionality, also relegated to that module). This module is fed by the FD and RIN waveform inputs of the SP, and it outputs frequency shifting actuation signals to the external tunable laser that is optically tapped into our OFS.
(v-c) LASER CONTINUAL TUNING (sweeping) systems. We provide two embodiments of this capability in conjunction with our resonator-based OFS, (iii-c above) aka the preMOD QRSH , scc FIG. 9 section (a) , and in conjunction with the DI-based OFS, the preMOD QDSH (iii-c above), see FIG. 9 section (b). These embodiments, perform ‘offset sideband laser tuning’ , i.e. lock one of the modulation sidebands (imparted to the tunable laser by the preMOD dithering) onto a minimum or null point of the response of a passive fiber optic structure—an optical (anti-)resonance spectral point in the first, preMOD QRSH, resonator-based embodiment, and a null of the DI response in the second preMOD QDSH DI-based embodiment.

In the first embodiment (FIG. 9 section (a)), a resonator is inserted in the s-path, and the s-laser is tuned to be locked at continually variable offset by having an FLL (using one of our OFS embodiments as the FLL frequency discriminator) capture one of its sidebands and maintain it at the bottom of an anti-resonant notch of the resonator. The laser may be tuned (locked) to the stable bottom of an anti-resonant notch of the resonator. The variable offset of the laser optical frequency is attained by tuning the s-path PM dither frequency to change the sidebands spectral spacing, while also coarse-tuning the s-laser in unison, shifting it away, such as to maintain the sideband within the relatively stable resonator notch, which is used as an absolute frequency reference. A coarse scan of the s-laser optical frequency and/or the r-path PM dither frequency initializes having the FLL capture the sideband into lock in the resonator notch and from there the FLL maintains lock, as the PM dither frequency and laser frequency are tuned in unison.

This second embodiment (FIG. 9 section (b)), is based on a similar spectral concept, replacing the resonator notch by the spectral location of the null of the DI-interferometer. However, now the OFS FD output cannot be used as the frequency discriminator, but we disclose a concept akin to ‘DGD/FSR est’ module, albeit leveraged here for stabilized (low-phase noise) laser tuning rather than for DGD stabilization, as originally conceived for. Thus, unlike in (v-b), the DI-based laser tuning by offset sideband locking, disclosed here, is not a straightforward application of our OFS as a frequency discriminator to serve prior-art of laser stabilization feedback loops, but we disclose an adapted system, based on the innovative feedback loop of FIG. 9, section (b), using a DGD/FSR est' module to obtain information about the deviation of the sideband frequency away from the DI-interferometer amplitude response null. Two external elements needed to complement our embodiment to a complete ‘laser tuning locked loop’, are the tunable laser (equipped with the frequency actuation input port) and the dithering synthesizer driving our PM preMOD.

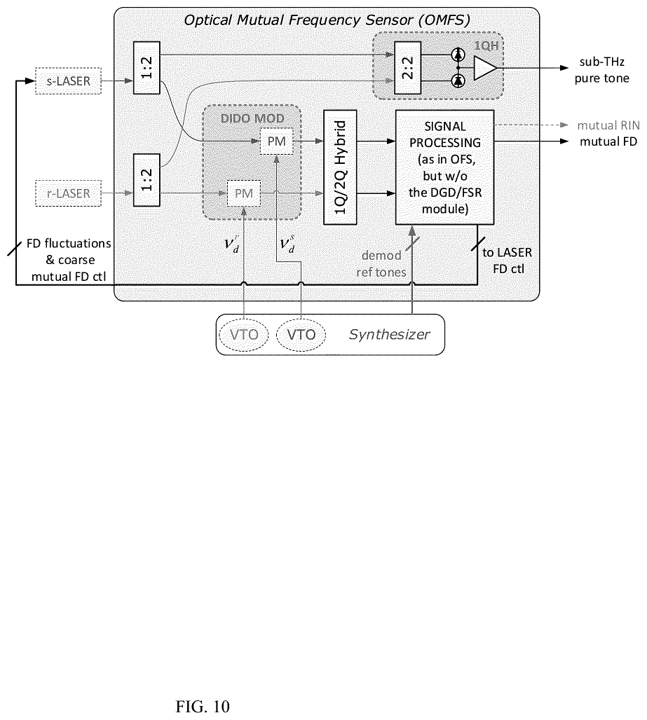

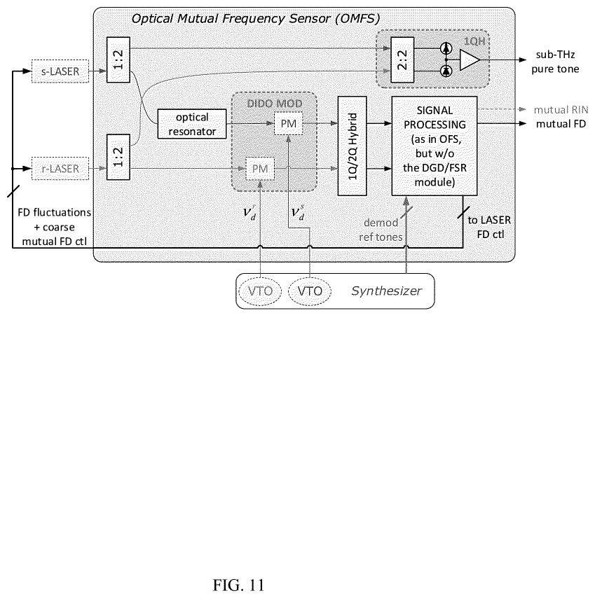

A third laser tuning system variant, also based on offset sideband locking, but using two lasers is disclosed in FIG. 11 below, and will be overviewed in conjunction with (v-f) below.
(v-d) Optical Length Sensor (OLS). There is also provided a method to estimate the slow interferometric bias phase wander, and we also disclose, in the context of the DI-based OFS (the preMOD QDSH), a technique to measure in real-time the DGD in the delay interferometer. The DGD measurement is effectively a measurement of the differential optical length variations of the two s- and r-paths, at multiwavelength resolution (fitting their scale of fluctuation due to environmental changes), distinct from the differential phase measurement of the interferometric bias wander (provisioned in our SP), which amounts to a length measurement on a sub-wavelength scale. Thus, in effect, our OFS equipped with the disclosed SP, may be used as an Optical Length Sensor (OLS) on two different length resolution scales, fine (sub-wavelength) and coarse (multi-wavelength).
(v-e) Optical synthesis of pure high-frequency RF or microwave (e.g., sub-THz) tones. This disclosed system, departing from the OFS paradigm, is referred to as Optical Mutual Frequency Sensor (OMFS). The OMFS (FIG. 10) senses the difference between the FDs of two independent laser sources (or modulated incoming beams)—this quantity being called mutual-FD. It also optionally measures a linear combination of the field amplitude fluctuations of the two laser, a quantity called mutual-RIN.

The OMFS is the sensor element within a complete optical Frequency Locked Loop that may lock the two CW lasers at a prescribed (and adjustable) frequency offset. By using the mutual-FD waveform generated by the OMFS as an error signal and feeding this error signal into the loop controlling the frequencies of at least one of the lasers, enables stabilizing the frequency difference between the two laser. This further enables electro-optically mixing optical taps of the two lasers (the two unmodulated beams, prior to their being input into the OMFS), e.g. by combining the two tapped lasers in a single-ended PD, as in prior art, or preferably, mixing them in a single-quadrature hybrid, as we teach for improved SNR. The optical mixing of the two unmodulated laser beams generate a high-frequency electrical (e.g., sub-THz) tone, featuring extremely high spectral purity, by virtue of the mutual-FD feedback into the PLL. This system may be viewed as a generalization of the ‘optical synthesizer. Our OMFS also makes use of an external synthesizer, in a modality described, in order to attain tunability of the high-quality generated sub-THz beat tone, but here we merely disclose the OMFS sensor element for the overall FLL, which may be described as an ‘optical synthesizer’ (comprising the two laser sources, at one of them tunable, our OMFS and the electronic synthesizer). The means to tap the two CW lasers (prior to being input into the DIDO MOD) and electro-optically mix them to generate a high-frequency high-spectral purity beat tone, is also included within the OMFS. Our preferred disclosed means is a 1QH (yielding improved Signal to Noise Ratio (SNR)).
(v-f) OMFS-assisted offset-sideband-locking of two lasers to a resonator mode. Yet another laser tuning system is disclosed in FIG. 11, for tunable offset sideband locking of a pair of lasers, assisted by an optical resonator, albeit with a pair of lasers, using the OMFS mutual FD sensing capability (rather than with a single laser as seen in FIG. 9, assisted by the OFS). The objective is to have the two lasers have optical frequencies at prescribed, adjustable mutual spectral separation, such as to generate a spectrally pure yet tunable electrical beat frequency, but in addition to have the capability of precision-tuning the two absolute optical frequencies (while retaining the prescribed mutual spectral separation). One possible application of this capability would be optical network analysis.

In this embodiment, not only is the sub-THz beat tone accurate and tunable in frequency (as set by means of the synthesizer) but the two optical frequencies are relatively accurately set in absolute terms, since the s-laser is sideband-locked to a resonant mode (an anti-resonant frequency) of the passive resonator in the s-path, whereas the r-laser is tuned at prescribed offset away from the s-laser (using the OMFS principle). The spectral stability of the resonator is then transferred to both the s-laser and to the r-laser, while the spectral separations are adjustable.

Our multitude of disclosed embodiments consists of all possible combinations of elements, the first element of which being one of the sub-embodiments under criterion (i), the second element of which is one of our sub-embodiments under criterion (ii), the third element of which is one of our sub-embodiments under criterion (iii) and the fourth element of which is one of our sub-embodiments under criterion (iv). We shall not specifically enumerate here the multitude of 4-tuple combinations of sub-embodiments forming our embodiments, but in the sequel we elaborate on the structure and functionality of some sample sub-embodiments out of the full set, explaining their functionality, utility and their principle of operation and even providing in most cases comprehensive mathematical modeling of the physical and signal propagation behavior of these sub-embodiments. In any case we supply sufficient explanation in order to establish the key features and their principles of operation. The rest of our embodiments within the set of the 4-tuple combinations may be inferred by those skilled in the art by extrapolation and adaptation of those representative embodiments that are going to be elaborated on in the sequel.

Optical hybrids are prior-art opto-electronic modules (DISO for the 1QH and DIDO for the 2QH) having two optical inputs and a single or dual electrical output representing information either of a single quadrature (denoted Q(t)) or both quadratures (denoted I(t) and Q(t)) of the beat signal between the two incoming beams. The single-quadrature hybrid (1QH) and dual-quadrature hybrid (2QH) aka IQ-hybrid (IQH), as introduced in the context of the DI in the topic above, are key modules used in coherent communication, over the last decade making inroads into interferometric sensing as well.

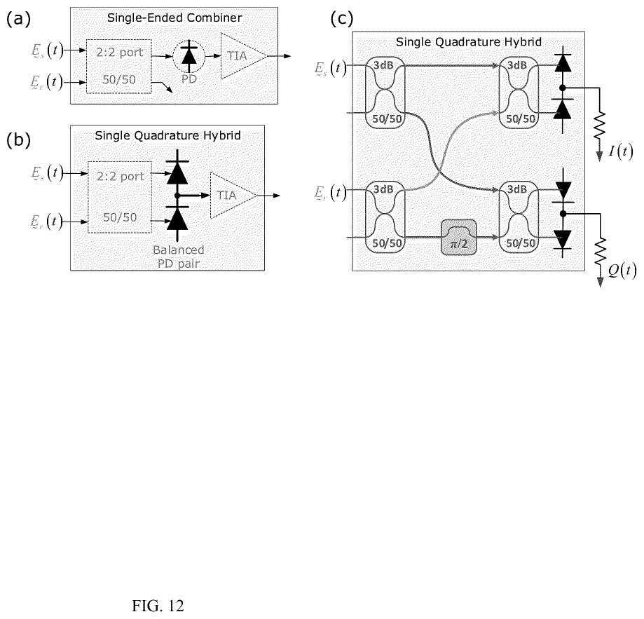

Both Hybrid types (1QH and 2QH) are more efficient than a combiner+single-ended PD shown in FIG. 12 section (a).

A 1QH (FIG. 12 section (b)) terminates the two incoming signals (here the IDT s- and r-outputs) by a 2:2. A pair of PDs is used placed on the two output ports of the 2:2. The 2:2 may be realized as an Optical Directional Coupler or as a MultiModeInterference (MMI) coupler (for fiber or integrated optics implementations) or as an optical beamsplitter (for discrete-optics based implementations comprising free-space-propagations). The two PD currents are subtracted off (this arrangement is called ‘balanced-PD’). The photocurrents difference may be generated by a pair of back-to-back photodiodes, taking the output current at the mid-point connection or using a differential TIA with its +/− input ports fed by the two respective PDs.

The dual-quadrature hybrid (2QH aka IQH), shown in FIG. 12 section (b), is an opto-electronic module with two optical inputs and a pair of electrical outputs, denoted I(t) and Q(t) here, internally consisting of a pair of 1QH modules one used for extracting the I-quadrature and the other for extracting the Q-quadrature. Refer to one input (typically the top one in our drawings) of the IQH as the signal-port (s-port) and to the other IQH input (typically the top one in our drawings) of the IQH as the reference-port (r-port). Both s- and r-inputs of the IQH are split two-way 50-50 by means of a pair of 1:2 splitters. One of the two split s-signals along with one of the split r-signals are optically interconnected by waveguides leading to the two inputs of one of the two 1QH blocks comprised in the IQH. The electrical output of which is the I(t) signal representing the in-phase quadrature component. The other split s-signal and with the other split r-signal are optically interconnected by a pair of waveguides leading to the two inputs of the second one of the 1QH modules. The electrical output of this second 1QH is the Q(t) signal representing the in-quadrature component. Collectively, the signals I(t) and Q(t) are the two outputs of the IQH—the quadrature components of the optical beat between the s-port and r-port optical input signals into the IQH).

To recap, we list three optical combining+photo-detection options for the beams emerging from the IDT of a two-beam interferometer (FIG. 12), in order of successively more complex, but delivering improved performance relative to predecessors in the list: (i) optical-combiner+single-ended-PD (ii) 1QH (iii) IQH.

### (Optical) Delay Interferometers (DI)

An optical Delay Interferometer (DI) aka Delay Line Interferometer (DLI), (FIG. 3) consists of means of splitting the light to feed a pair of delay lines of different optical lengths terminated in means to recombine the light and to photo-detect the light. The pair of asymmetric optical delay lines, forming optical core of the DI, will be referred to here as IDT optical-delays. Note: The case when the two optical delays are nominally equal is outside the scope of the DI definition.

Such case may be referred to as ‘symmetric Mach-Zehnder-Interferometer’ (MZI). If a DI is implemented as an MZI, then it is by definition an asymmetric MZI, ‘asymmetric’ meaning its two delay lines are unequal optical lengths.

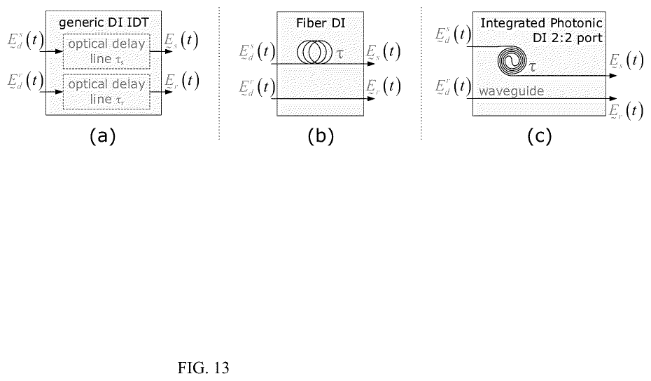

The pair of constituent IDT optical-delays may be implemented (see FIG. 13) in fiber-optics, or in integrated optics. Each ‘optical delay line’, is an optical SISO system (1:1port) realized either as a piece of optical fiber or an optical waveguide or a free-space path—usually a piecewise rectilinear path breaking direction at reflections off mirrors. The well-known Michelson (MI) or asymmetric Mach-Zehder interferometers (MZI) are in fact free-space DI interferometers. FIG. 4 already depicted free-spaced DIs based on the MI and MZI, albeit going beyond the state-of-the-art by having them retrofitted with pre-modulation and hybrid detection as per our disclosure.

To envision prior-art free-space DI implementation options one may imagine FIG. 4 having the preMOD and the hybrid detector removed and using instead simple single-ended combining+PD.

To recap, at the top block diagram level (FIG. 3), the DI is the tandem connection of three elements:
i. the means-to-split the light.
ii. the two asymmetric optical delays in the IDT.
iii. the means-to-recombine-and-photodetect the light.

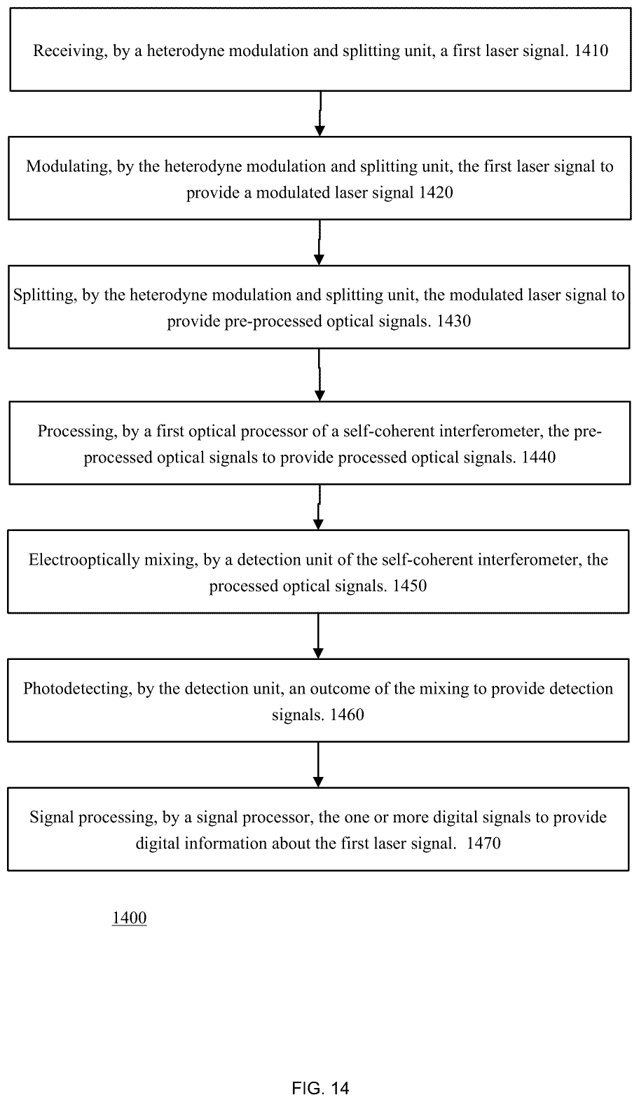

The means-to-split the light is essentially an optical 1:2 splitter, possibly with adjustable splitting ratio, typically with fixed (often 50-50) power splitting ratio. The means-to-recombine the light may typically consist of a 2:1 passive optical combiner, in which case the means-to-photodetect the light is simply a single PD terminating the output port of the 2:1 combiner, followed by a TransImpedance Amplifer (TIA). The PD+TIA form an optical Receiver (Rx). The aforementioned 2:1 passive optical combiner+single PD is typically realized as a passive 2:2 with light at one of the two output ports being discarded while light from its other port is fed into the single PD of the Rx. The aforementioned 2:2 is a passive 2:2DIDO optical system such as an optical directional coupler or a MultiModeInterference (MMI) coupler (for fiber or integrated optics implementations) or an optical beamsplitter (for discrete-optics based implementations comprising free-space-propagations). This arrangement is referred to as ‘optical-combiner-with-single-ended-PD’. A DI based on this structure is henceforth referred to as ‘DI-with-single-ended combiner’. Alternatives to this type are the DIs depicted in FIG. 14. The ‘classic’ DI is denoted (a), has its two optical delays terminated in a single-ended combiner+PD. Improved performance is attained by terminating the DI in a single-quadrature hybrid (1QH) or in a dual-quadrature hybrid (2QH), is denoted (b).

To enable the DI for heterodyne post-detection processing, prior art inserted an FM or PM modulator in one of the two IDT paths, say into the r-path, as shown in (c) depicting the prior-art DI-based ‘Delayed Self-Heterodyne’ (DSH) interferometer, elaborated next.

The propagation of the noisy laser field CE through a generic relatively smooth general optical system can be modeled as follows:

{tilde under (E)}ₒ(t)=h(t)⊗{tilde under (E)}_{c}(t)≅{\tilde{c}₀[1+ε(t)]+\tilde{c}₁\dot{ε}(t)+\tilde{c}₂[\dot{φ}²(t)=\ddot{ε}(t)]+j[\tilde{c}₁\dot{φ}(t)+\tilde{c}₂\ddot{φ}(t)]}A_{c}e^{jφ(t)} (1)

This formula clearly highlights the first-time the transformation of both the phase derivative (scaled FD) and RIN field fluctuation through the optical system. Conventional interferometric modeling turns out to yield formulas equivalent to retaining just the terms with the \tilde{c}₀, \tilde{c}₁ PTS-taps. The consequences of the second-order term (the one with PTS-tap \tilde{c}₂) are not yet recognized. This term is associated with φ(t)=2π\dot{f}_{δ}(t), which is the derivative of the FD, i.e. a hitherto unrecognized optical chirp-dependent term typically arising in interferometric systems, particular in the interferometric systems disclosed here. Granted the \tilde{c}₂ tap and the rate of change of the FD, weighted together may be at a negligible level, but there are interferometric systems and regimes of operation thereof, such that the second-order chirp-related term be non-negligible. We further note that the RIN fluctuation terms, ε(t) and its derivatives do not occur at all in the imaginary part of the term in braces in the equation. This indicates that detection systems extracting the imaginary quadrature of the filtered output of an optical system fed by a noisy CW laser ‘optical carrier’ are dependent solely on the FD and its derivative (in the second-order PTS approximation) but not on the RIN terms. Thus, OFS systems implementing the configuration described above are immune to the RIN impairment.

### Disclosing the Most General preMOD Quadrature Self-Heterodyne (QSH) OFS

The disclosed OFS system (with a single optical input) was seen to most generically consist of the concatenation (linear chaining) of the following four modules (FIG. 1 section (a)).
1. An Optical Modulator equipped with a pair of outputs, referred to as the dual-output preMOD, e.g., a SISO optical modulator such as a Phase Modulator (PM) or Frequency Modulator (FM) followed by a 1:2 optical splitter or some other internal arrangement in the dual-output pre-modulator module resulting in two optical outputs, e.g., having the 1:2 splitter first followed by two parallel modulators (amplitude or phase ones). For this type of dual-output preMOD we disclose a dual-drive MZM embodiment.

The electrical drive(s) to the optical modulator is (are) electrical multitone signal(s) in the sense defined in the preamble, either single sinusoids or superpositions of two or more sinusoids at frequencies that are commensurable or may be approximated as such. In case the preMOD comprises are two ‘children’ such as in the case of the IQ modulator (or even for the two parallel PMs forming an MZM), the two ‘children’ modulators are not to be necessarily driven by identical sinusoidal or multitone signals on their two electrical drive ports.
2. An optical 2:2 two-port (DIDO) with its two input ports fed by the two outputs of the pre-modulator, referred to as the Interferometric Dual Track (IDT). As a sub-family of embodiments, we may have the IDT consist of a pair of SISO systems in parallel, the two systems referred to as the s-path (signal path) or s-system and r-path (reference path) or r-system respectively.

Typically, the two SISO systems differ in their frequency responses. In turn, as a sub-sub-family of embodiments of the dual-SISO family, we may have the s-system as a SISO system featuring frequency-selectivity, while having the r-system as an optical delay line (ideally an all-pass system). An even more specialized sub-embodiment uses the DI-IDT, i.e., both the s- and r-paths are now optical delay lines (differing in their optical lengths by a path difference which is substantial when measured in optical wavelength units).

Note: If the dual-output pre-modulator consists of a PM or FM followed by a 1:2 splitter, and if the ‘interferometric dual-track’ consists of a pair of unequal optical length optical delay lines, then the said 1:2 splitter taken together with the ‘dual-track-delays’ section and with the combiner(s) internal to the optical hybrid following the ‘dual-track-delays’ (see next point) jointly form a Delay Interferometer (DI).
3. An optical Hybrid, be it a dual quadrature or single quadrature hybrid +Optical Receiver(s) photodetector(s)+electrical conditioning/amplification (e.g. TIA(s)) following the photodetectors.

For a single-quadrature hybrid there is a single electrical output, denoted Q(t), representing a single quadrature of the beat signal between the two optical inputs into the hybrid. For a dual-quadrature hybrid there is a pair of electrical outputs denoted I(t) and Q(t), representing the two quadratures of the beat signal between the two optical inputs into the hybrid. We say that the optical hybrid ‘terminates’ the OFS interferometer, though signal processing is performed on the hybrid electrical outputs.
4. A signal processing module (either analog or digital) acting on the one or two electrical output(s) of the Optical Hybrid to finally generate the FD and RIN waveforms, linearly encoded as electrical outputs of the OFS. The front-end of the signal processing module (following Analog-Digital Conversions if the signal processing module is realized digitally) consists of a stage performing demodulation(s) of the input electrical signal or signal pair from the optical hybrid stage (which was possibly digitized).

Since our disclosed OFS systems are all heterodyne, the first processing block within the signal processing module is a demodulator (DEMOD) bank, i.e., multiple demodulators provided in parallel. The need for a demodulators bank arises as the two s- and r-signals incoming into the optical hybrid consist of the laser source complex envelope modulated onto optical combs (Fourier series) as generated by the dual-output modulator. Therefore, the laser source complex envelope is redundantly spectrally shifted around each of the comb harmonics, forming a multiplex of modulated subcarriers.

The FD is the difference between the incoming optical signal instant optical frequency and a characteristic reference optical frequency of the IDT passive optical system, the optical splitter preceding it and the optical combiners following it which are embedded within the optical hybrid, which optical elements are jointly referred here as the ‘interferometric structure’. The reference frequency may be one of the eigenmodes of the said interferometric structure or a characteristic frequency thereof, whereat the transfer function of the said interferometric structure features an extremum.

### 1. Signal Processing for Dual-Quadrature Heterodyne Two-Beam Interferometers

We now disclose post-demodulation signal processing functionality beyond the state-of-the-art, enabling performance improvement for any two-path interferometer that is operated in heterodyne mode, provided its 2:1 port or 2:2 port combiner terminating the two-path interferometer is replaced by a dual-quadrature optical hybrid. The case of our prePM QDSH OFS treated heretofore is a special case of our generic post-demodulation signal processing functionality that we now disclose, which is applicable, in principle to all sub-embodiments (iii-a) to (iii-d) of the Interferometric Dual Track (IDT) under criterion (iii). Given the IDT of any two-path interferometer we disclose retrofitting it with a preMOD and also with dual-quadrature hybrid (IQH), by replacing the 2:1 port or 2:2 port combiner terminating the two-path interferometer with the IQH, following the IQH by a Signal Processor as essentially outlined in this section. The disclosed signal processing raises the useful signal level and reduces sensed FD distortion and noise, by enabling to estimate and compensate several key impairments which arise in prior-art heterodyne two-path interferometers (the prePM QDSH OFS being a special case):
(i) The photodetection process in the IQH is inherently affected by additive receiver noises: The shot-noise and the thermal noise of the receiver.
(ii) In heterodyne interferometry an electrical dither sinusoidal or multitone signal is applied in order to generate optical subcarriers offset from the optical carrier (such that the coherent mixing of these subcarriers with the carrier and among themselves at photodetection generates the heterodyne beat tone(s)). A disadvantage is that the energy is spread between the subcarriers such that each subcarrier is weaker than if homodyne interferometry were used (i.e., no dithering). This leads to loss of SNR which we disclose partially mitigating by adopting Maximal Ratio Combining (MRC) diversity technique.
(iii) In any heterodyne interferometer, a demodulator stage after photodetection is provided to extract the beat tone(s) among the received optical tones (the carrier and the subcarriers). A general problem to contend with is that due to the latency between the dithering point in the system and the optical photodetector and the demodulator following it, the received subcarrier(s), arrive at the demodulator with phaseshifts (called here ‘arrival phases’), which are to be estimated, such that these arrival phase may be compensated to prevent useful signal fading.
(iv) For heterodyne two-path interferometers fit or retrofitted with an optical hybrid, for recombination of the two optical paths, a limiting impairment turns out to be the IQ-imbalance of the dual-quadrature hybrid, which is compounded by additional IQ-imbalance that may be generated in the heterodyne
   IQ-demodulator stage (especially if demodulation is performed analogly), in case that IQ-demodulation rather than single-quadrature demodulation is used (which is the case in our Signal Processor).

IQ-imbalance is the departure from ideality of a dual-quadrature optical hybrid (and/or an electrical IQ demodulator) and/or of the complex-(IQ)-demodulator due to not having the two quadrature reference signals precisely at the nominal ±90° relative phase and not having precisely equal gains for the two quadratures. The IQ-imbalance, if not mitigated, translates in a nonlinear distortion of the FD-sensing characteristic of the OFS.
(v) Degradation by the so-called ‘technical noise sources’ arise stemming from a multitude of sources, in particular: (v-a) low-frequency noise. (v-b) noise injected in the modulation process

We have seen that the preMOD approach is effective in mitigating (v-b), whereas (v-a) poses a fundamental limitations in that the performance of any OFS at very low-frequencies is compromises.

Major impairments which we may effectively address in our invention are (i)-(iv). To recap those:
(i) receiver shot and thermal noises. (ii) reduced power of each heterodyne subcarrier, (iii) arrival phaseshifts due to latency, (iv) IQ imbalance.

Whenever a dual-quadrature hybrid is used, the IQ imbalance becomes an important factor to mitigate. In addition, for heterodyne interferometry there is always a task withstanding to compensate for the latency between the applied dither, used for generation of subcarriers offset from the optical carrier, and the received subcarrier(s), which arrive at the demodulator with a phaseshift (called here ‘arrival phase’), which is to be estimated, such that the arrival phase may be compensated.

These impairments are mitigated in the post-quadrature-photodetection signal processing disclosed below, aiming to improve the performance of heterodyne two-path generic interferometers.

The generic disclosed post IQH-signal processing estimating/mitigating the impairments surveyed above, is exemplified in the sequel, in particular, for our special instance of prePM QDSH OFS interferometer. However, more generally, the disclosed signal processing techniques pertain to heterodyne two-beam interferometers at large, provided that the interferometers are equipped with a dual-quadrature optical hybrid. In particular, these disclosed techniques may be used with the OFS interferometers described in Belleau et al (delayed self-homodyne with IQH) as well in any of our preMOD QDSH schemes in this invention.

A top level block diagram of the disclosed post IQH-signal processing (FIG. 6), depicts the main signal processing modules and their interconnections. In the following sections we describe the rest of the modules in the post-hybrid signal-processor of FIG. 13, their functionalities and their interconnects.

This diagram is applicable to our generic preMOD QDSH OFS family of embodiments (and applicable in particular, to the prePM QDSH specialized embodiment, which is used as a concrete example).

The implementation of the overall Signal Processor is analog or preferably digital if feasible. In closed-loop systems based on the OFS, the digital latency, in particular due to the A/D and D/A interfaces may impair the feedback loop operation, whereas for laser characterization systems there is no feedback hence no signal processing low-latency requirement, thus a digital implementation is more suitable. Nevertheless, a digital implementation may still be feasible for OFS-based closed loop systems as well, depending on the latency requirement. It is in fact preferred to have the main data-path implemented analogly, for fast feedback but have slower-speed loops, adjusting parameters in the data-path, implemented digitally.

To account for closed-loop latency requirements, we may have the main data-path, for the fast feedback chain implemented analogly, including fast analog actuators, whereas the estimation of various impairments which are relatively slow, and need not be rapidly tracked (such as IQ-imbalance and carrier phase-estimation), performed digitally, to implement slower-speed loops, adjusting parameters in the fast analog data-path. These digital parts of the Signal Processor would evidently be interfaced to the analog chain by means of A/D and D/A converters (at the lower speeds).

Note: Implementation variants of our post-photodetection processing chain of the block diagram depicted FIG. 13, may be conceived based on our inventive concepts, as should be evident to those skilled in the art by adaptation of the novel principles of operation outlined here.

### Impact of IQ imbalance on Hybrid-Based Photo-Detection and Subsequent Demodulations

Non-ideal optical hybrids exhibit IQ-gain and IQ-phase errors, namely the scaling factors of the I and Q components slightly differ and so does the relative phase of the two references which are nominally in quadrature, but in practice their phase difference may deviate from ±90°.

It is shown in that IQ-Imbalance (IQI) of a non-ideal demodulator (or equivalently optical hybrid in our case) may be modeled as a widely linear transformation (WLT) operating on the ideal hybrid or demodulator output, \tilde{X}(t).

### DEMOD Bank for the Disclosed prePM QDSH OFS

With or without IQ-imbalance useful pieces information (the ‘messages’) are FDM-encoded onto various harmonic sub-carriers, e^{jnω}^{_{d}}^{t}, which may be most generically written as

[symbol]

(t)=Σ_{n=-∞}^{∞}Xₙ(t)e^{jnω}^{_{d}}^{t}.

The first module in the signal processing chain is the demodulator (DEMOD) bank, tasked with ‘peeling off’ the messages back to baseband, and passing them on to the next stages in order to distill from them the target information to be sensed.

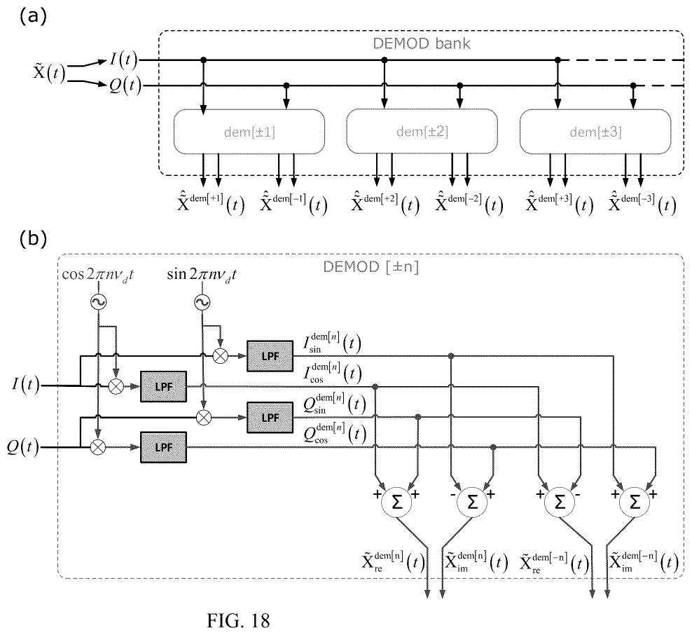

Since the actual implementation of the constituent complex demodulation units of order n, described in section, entails multiplications by nominal cos nω_{d}t and sin nω_{d}t sine reference signals, (FIG. 18 section (b)) then imperfections in the relative phases of the cosine and sine references and their gains contribute IQ imbalance from the demodulator bank as well, which compounds with that generated in the dual-quadrature optical hybrid (which is itself demodulator with transducing from the optical to the electrical domains). In fact, the WL-model for the optical hybrid may represent, as is, the net IQ-imbalances for each separate harmonic order, n, as associated with both the hybrid and the electrical demodulator combined.

### ‘DEROT bank’ Carrier Phase Recovery Actuation to Mitigate Channel Latency

Carrier recovery is a required in synchronous demodulation. For optimal operation, the OFS should account for the transmission-to-reception latency ('transmission' standing here for the dithering (multi)tone driving the dual-output preMOD, and ‘reception’ refers to the electrical inputs into the demodulator bank, following photo-detection by the hybrid) induces an ‘arrival phase-shift’ onto the dither carrier, which may cause fading of the demodulated amplitude in the dither-synchronous detection stage, unless the arrival phase-shift is estimated and mitigated by shifting the phase of the reference signals in the demodulator bank to match the ‘arrival phase-shift’. Moreover, the ‘arrival-phase-shift’ depends on (in fact is proportional to) the order, n, of the demodulated subcarrier.

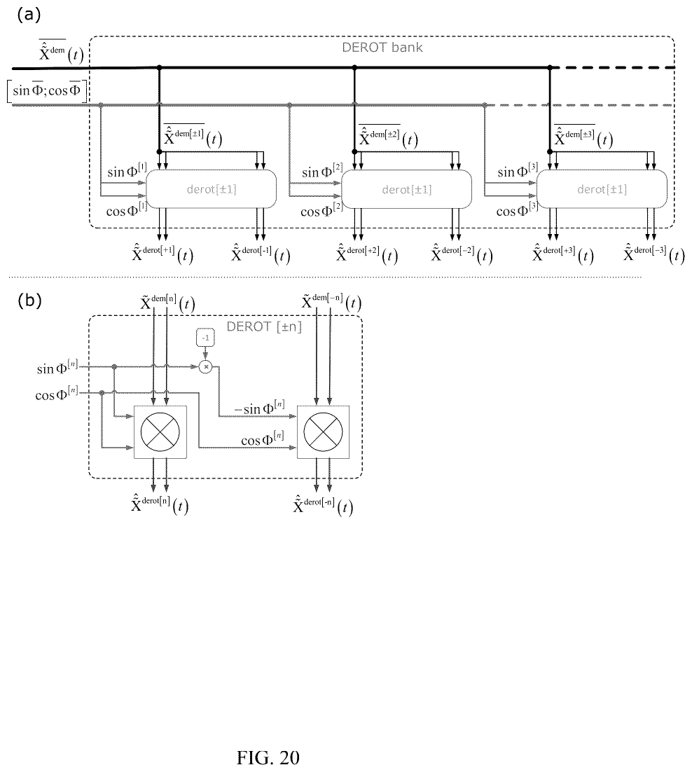

The processing module named ‘DEROT bank’ of FIG. 20 provides for a key part of phase-recovery, the actuation of phase ‘derotations’, applying suitable additive or subtractive corrections to the impaired arrival phases (the means to estimate the arrival phases to be derotated is provided in the ‘WL Ellipse est bank’ module, which feeds back to the DEROT bank estimated derotation angles—(in the ‘WL Ellipse est’ module, the estimation of the required derotation angles is jointly performed with the estimation of the IQ-imbalance).

Note: The DEROT functionality might be integrated within the DEMOD bank module, hardware-wise, but conceptually we treat it as a separate module in the chain, following right after the DEMOD bank.

Having individual access to all order[n] (with n=±1, +2, +3, . . . ) complex demodulated subcarriers, as provided at the outputs of DEMOD bank, which are fed into the DEROT bank, enables independently derotating the phases of the individual complex harmonic subcarriers (and subsequently estimating, in the ‘WL ellipse est’ module, updates for the derotations to be actuated for each individual harmonic sub-carrier). The complex demodulated harmonics \tilde{X}^{dem[n]}(t)=\tilde{X}ᵣₑ^{dem[n]}(t) +j\tilde{X}ᵢₘ^{dem[n]}(t), as extracted by the DEMOD bank prior stage, are sent into the DEROT over pairs of wires {\tilde{X}ᵣₑ^{dem[n]}(t), \tilde{X}ᵢₘ^{dem[n]}(t)} arriving for each of the ordern=±1, ±2, . . . subcarriers. The n-th derotation unit of the DEROT bank outputs a pair of wires {\tilde{X}ᵣₑ^{derot[n]}(t), \tilde{X}ᵢₘ^{derot[n]}(t)} carrying the derotated complex signal

\tilde{X}^{derot[n]}(t)=\tilde{X}ᵣₑ^{derot[n]}(t)+j\tilde{X}ᵢₘ^{derot[n]}(t). (2)

In complex form, the functionality of the n-th DEROT unit, derotating the n-th subcarrier, is described as

\tilde{X}^{derot[n]}(t)=\tilde{X}^{dem[n]}(t)e^{jϕ}^{^{[n]}} (3)

with ϕ^{[n]} the derotation angle. We refer to the DEROT module as DEROT bank (FIG. 20 section (a)), as derotations are independently performed in parallel, evaluating (3) for each of the ordern=±1, +2, . . . subcarriers.

The actual implementation of the n-th DEROT unit is in terms of the I/O pairs of real-valued signals (FIG. 20 section (b)), representing the re/im-parts of (3), performing four real-valued multiplications (corresponding to rotations, using real multipliers by the factors [symbol] ^{[n]}, [symbol] ^{[n]}, which are isomorphic to the arithmetic of complex multiplication), equivalent to the following vector-matrix multiplication:

$$[ \begin{matrix}{\tilde{X}}_{r e}^{derot [ n ]} ( t ) \\ {\tilde{X}}_{i m}^{derot [ n ]} ( t )\end{matrix} ] = ( \begin{matrix}cos {ϕ}^{[ n ]} & - sin {ϕ}^{[ n ]} \\ sin {ϕ}^{[ n ]} & cos {ϕ}^{[ n ]}\end{matrix} ) [ \begin{matrix}{\tilde{X}}_{r e}^{dem [ n ]} ( t ) \\ {\tilde{X}}_{i m}^{dem [ n ]} ( t )\end{matrix} ]$$

An implementation of the complex multiplication by means of just three real-valued multipliers is available—in fact, any available implementation of the complex multipliers indicated in FIG. 20, section (b) may be used to implement the equivalent of the complex multiplication in (3).

Nevertheless, for simplicity we assume the four-real-multipliers based implementation of (3), as described below.

The demodulations should be performed for all orders n=±1, +2, . . . but it is convenient to design a DEROT building block generating both order[n] DEROT and its antipodal order[−n] DEROT.

Thus, in addition to the linear transformation above we shall also need to include in this DEROT building block the evaluation

$$[ \begin{matrix}{\tilde{X}}_{r e}^{derot [ - n ]} ( t ) \\ {\tilde{X}}_{i m}^{derot [ - n ]} ( t )\end{matrix} ] = ( \begin{matrix}cos {ϕ}^{[ - n ]} & - sin {ϕ}^{[ - n ]} \\ sin {ϕ}^{[ - n ]} & cos {ϕ}^{[ - n ]}\end{matrix} ) [ \begin{matrix}{\tilde{X}}_{r e}^{dem [ n ]} ( t ) \\ {\tilde{X}}_{i m}^{dem [ n ]} ( t )\end{matrix} ]$$

is It turns out that the required derotation angles should be linear in the order, thus satisfy, ϕ^{[n]}=−ϕ^{[-n]}

(this stems from the derotation angles, ϕ^{[n]}, needing to track the arrival phases of order[n], which in turn are linear in n, i.e., given by nϕₐ—see the subsection titled ‘Modeling the DEROT module’ below).

Since the actuated derotation angles, ϕ^{[n]}, are meant to cancel the arrival phases, nϕₐ, for each order[n], we conclude that we should design the pairs of derotation angles at antipodal ±n orders, to also be odd in the order index, i.e., satisfy ϕ^{[-n]}=−ϕ^{[n]}, such that:

ϕ^{[n]}=nϕ^{[1]}∴ϕ^{[-n]}=−ϕ^{[n]}=−nϕ^{[1]}.

Therefore, making substitution the n→−n in the previous equation yields,

(using cos ϕ^{[-n]}=cos[−ϕ^{[n]}]=cos ϕ^{[n]}, sin ϕ^{[-n]}=sin[−ϕ^{[n]}]=−sin ϕ^{[n]}):

$$[ \begin{matrix}{\tilde{X}}_{r e}^{derot [ - n ]} ( t ) \\ {\tilde{X}}_{i m}^{derot ( [ - n ]} ( t )\end{matrix} ] = ( \begin{matrix}cos {ϕ}^{[ n ]} & sin {ϕ}^{[ n ]} \\ - sin {ϕ}^{[ n ]} & cos {ϕ}^{[ n ]}\end{matrix} ) [ \begin{matrix}{\tilde{X}}_{r e}^{dem [ - n ]} ( t ) \\ {\tilde{X}}_{i m}^{dem [ - n ]} ( t )\end{matrix} ]$$

The linear transformations needed to be applied on the DEMOD order[n] outputs and DEMOD order[−n] outputs are illustrated above. Note: The DEMOD bank outputs \tilde{X}ᵣₑ^{dem[n]}(t) being complex, there is no Hermitian symmetry available to exploit, therefore performing the linear transformations mentioned above requires 4 distinct multipliers for each equation, i.e., a total of 8 multipliers (even though there are only two distinct matrix elements, the cosine and the sine of ϕ^{[n]}, but their inputs are distinct in the two equations and there is no way to share amplifiers.

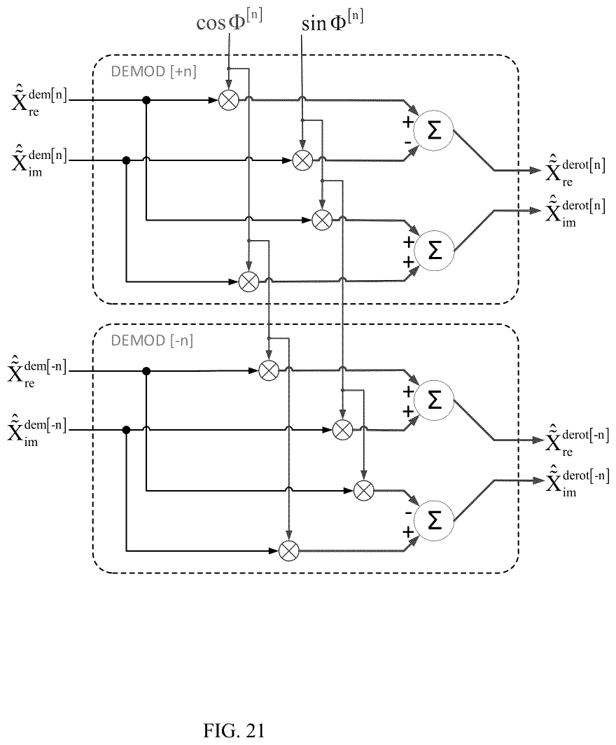

The implementation of the ‘order[n] DEROT unit’ building block using 8 multipliers is depicted in FIG. 21.

The full DEROT module (FIG. 20) is in principle obtained by parallel arraying of the ‘order[n] DEROT units’ (detailed in FIG. 2) for the various orders, n=±1, +2, . . . , up to the highest order adopted in the OFS design (typically the second or third order).

In the next section 2 we disclose unique functionality of the signal processing back-end module, enabling to estimate the arrival phases n\hat{ϕ}ₐ, which are jointly estimated along with the WL-parameters describing the IQ imbalance, for the dual purpose of mitigating the IQ imbalance based on the extracted estimate and setting the derotation phases \hat{ϕ}^{[n]} in the DEROT module.

Such signal processing functionality will be described for definiteness in the context of particular opto-electronic front-end of our disclosed prePM QDSH OFS, but it may be generally adapted to any of our OFS embodiments.

2. Joint Carrier Phase Recovery & Estimation/Mitigation of IQ Imbalance in prePM QDSH

Having individual access to both the n-th order and −n-th order demodulated subcarriers, by means of our disclosed all-complex-demodulator, enables estimating (and subsequently mitigating) the transmission impairments of the arrival phase mismatch and it turns out that it also enables estimating the IQ imbalance of the optical IQ hybrid (IQH) and the demodulation module itself (if implemented in the analog domain with mixers driven by sine and cosine waveforms).

### 3. IQ-Imbalance (IQI) Estimation and Compensation Based on Widely Linear Methods

Some of the disclosed signal processing functionality more generally pertains to any heterodyne two-path interferometer provided the 2:1 port or 2:2 port combiner terminating the two-path interferometer is replaced by a dual-quadrature optical hybrid. Whenever a dual-quadrature hybrid is used, the IQ imbalance becomes an important factor to mitigate. Moreover, for heterodyne interferometry there is always a task withstanding to compensate for the latency between the applied dither, used for generation of subcarriers offset from the optical carrier, and the received subcarrier(s), which arrive at the demodulator with a phaseshift (called here ‘arrival phase’), which is to be estimated, such that the arrival phase may be compensated. The estimated parameters are respectively used in an IQ-rebalance module which compensates for the IQ-imbalance and in the upstream derotation stage of the demodulator or demodulators bank. The two estimation tasks of compensating for the arrival phases (carrier phase recovery) and for the IQ-imbalance (IQI) are innovatively combined to be jointly performed in a ‘Phase Recovery & IQI comp’ sub-system in the top-level block diagram (FIG. 6) of the Signal Processor. More specifically, the ‘WL ellipse est’ module jointly estimates the parameters are respectively needed in the ‘DEROT bank’ and ‘IQ comp bank’ modules the counteract the arrival dephasing and IQ-imbalance-dephasing and to compensate for IQI. The ‘WL ellipse est’ estimates and iteratively feeds parameters needed by the two upstream ‘DEROT bank’ and ‘IQ comp bank’ modules to actuate compensations.

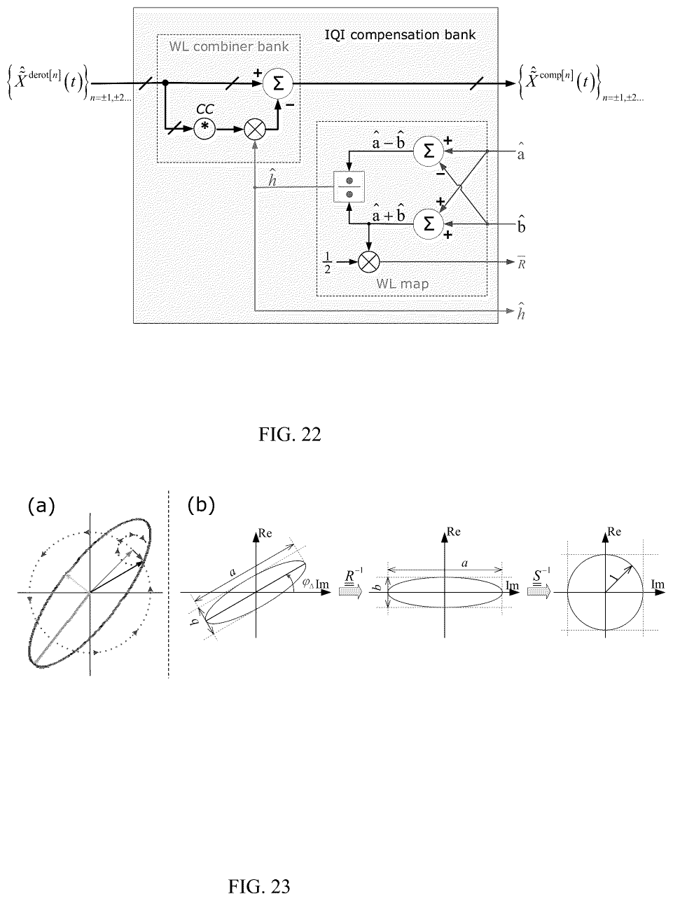

If left uncorrected, IQ-imbalance (IQI) would generate a nonlinear distortion in FD-to-sensor-output transducer characteristic of the OFS. We will be in a position to estimate the severity of this distortion, once we address the estimation of the FD, but it turns out that the distortion may be appreciable, even for typical imbalances of the IQ-gains and IQ-phases of the order of 1% and 1°, respectively. FIG. 22 describes the ‘IQI-comp-bank’ module compensating for the eccentricity of the ellipse resulting from the WL-distortion, this module following the ‘DEROT bank’ compensating for the tilt of the ellipse. The IQ-compensation process is graphically depicted in FIG. 23.

These two modules are assisted by the ‘WL ellipse est’ module which estimates their needed parameters. The three modules functionally a ‘Phase Recovery & IQI comp’ sub-system working in unison, as treated in this section.

The ‘WL ellipse est’ module receivers a collection of samples on or close to a general ellipse in [symbol] ² and extracts the ellipse geometric parameters, [a, b, φ₆₆], the major and minor semi-axes, a,b, and the tilt angle of the major semi-axis.

A block diagram detailing the ‘IQI-comp bank’ module, the signal flow and its internal constituent blocks , is depicted in FIG. 22. The input into the ‘IQI-comp bank’ module is the vector, { [symbol] ^{derot [n]}(t)}_{n=±1, ±2, . . .} fed from the outputs of the preceding ‘DEROT bank’. The output of the ‘IQI-comp bank’ module is the vector {\tilde{X}^{comp[n]}(t)}_{n=±1, ±2, . . .} . The module is described as a ‘processing bank’, since its I/O consists of vectors of elements independently processed

Back to the signal processing structures, the other constituent block within the ‘IQI-comp bank’ module is the ‘WL map’ which acts on the ellipse geometric parameters a, b, as provided from the ‘WL ellipse est’ module (which implements an ellipse estimation algorithm), mapping a, b into the WL-parameters h, R̅, implementing the following transformations on the [a, b] input vector

$$h = \frac{a - b}{a + b} , \overline{R} = \frac{a + b}{2} .$$

Only the eccentricity parameter, h, is needed in the WL-equalizer (to cancel the ellipse eccentricity and turn it into a circle). The R̅ parameter is also output as it is indicative of the demodulated and compensated signal strength for each harmonic order[n], thus it is passed to other signal processing modules to assist in other calibrations.

The internal structure of the ‘WL map’ unit in FIG. 22, is to be interpreted as replicating the shown WL-combiner for each of the harmonic orders. The meaning of having ‘vector wires’ is having a copy of the indicated WL-combiner for every order[n] element of the vector, on the ‘vector wire’. Thus, all operations in the ‘WL equalizer bank’, which is stylized as a vector-to-vector mapping, are to be interpreted element-wise for each of the branches of the ‘bank’. In particular the symbolic multiplier with h signifies elementwise multiplication of an incoming vector with the vector of WL-taps {h^{[n]}}_{n=±1, ±2, . . .} , the preceding CC operation is performed elementwise, the summation is a sum of vectors, etc. Similarly, the ‘WL ellipse est’ module is actually a ‘bank’ as well. The estimations of the [a^{[n]}, b^{[n]}, φ_{Δ}^{[n]}] parameters are actually performed in parallel, independently for each of the orders, n.

Note: Further to the discussion above, an option for the ‘WL map’ block is to collect its output vectors {h^{[n]}}_{n=±1, ±2, . . .} , {R̅^{[n]}}_{n=±1, ±2, . . .} , and prior to passing {h^{[n]}}_{n=±1, ±2, . . .} the ‘WL equalizer bank’ to average over the elements of {h^{[n]}}_{n=±1, ±2, . . .} , yielding h_{avg}, which may be passed to the ‘WL equalizer’ , as a common tap, for WL-compensating all harmonic orders. The advantage of this is that the averaging makes h_{avg} a less noisy parameter. The averaging over the {h^{[n]}}_{n=±1, ±2, . . .} may be an arithmetic one, or a weighted average may be used according to the {R̅^{[n]}}_{n=±1, ±2, . . .} , (a form of Maximal Ratio Combining) which should improve the signal-to-noise ratio of the random variable h_{avg}. A similar averaging procedure could be performed on all tilt angles, ϕ_{Δ}^{[n]}, distinguishing between even and odd orders which have their ellipses orthogonal.’

The IQI comp procedure outlined here should be run at system bringup and may be used for slow iterative tracking as well, whenever the IQI parameters are not stable, e.g. over temperature variations. However, the part of the IQI comp procedure ‘straightening up’ the ellipse has to be run iteratively, as the tilt angle, φ_{Δ}(t), is less stable and typically randomly drifts on sub-second time-scales. The ‘WL Ellipse est’ module is fed by blocks of data on a time-scale much shorter than the rate of drift of the tilt angle, φ_{Δ}(t).

The ‘Phase Recovery & IQI comp’ sub-system (highlighted in the top-level block diagram of the Signal Processor in FIG. 6), as described in this section, is capable of compensating any IQI generated in the path from the photo-detectors to the inputs of this subsystem. In fact, further to the dual-quadrature optical hybrid being a source of IQI, it turns out that IQI may also be generated in the ‘DEMOD bank’, in case the demodulations are implemented analogly. But because the rate of update of the ‘WL-equalizer bank’ is relatively slow, a mixed-signal design of the OFS signal-processor is supported, whereby the DEMOD and DEROT modules are implemented in analog fast path for rapid feedback, albeit the analog subsystems are digitally assisted to track arrival dephasing and IQI.

### Maximal Ratio Combining Following Demodulations in Our prePM QDSH OFS

The next module in the disclosed chain is the ‘MRC diversity combiner’ where MRC stands for Maximal Ratio Combining. This module takes as input a vector of baseband signals and ‘diversity combines’ these signals into a scalar signal \tilde{\hat{X}}_{bb}(t)which is an estimate (denoted by a triangular hat) of the baseband statistic \tilde{X}_{bb}(t).

### FD & RIN Estimator (Rect2Polar Conversion, PLL)

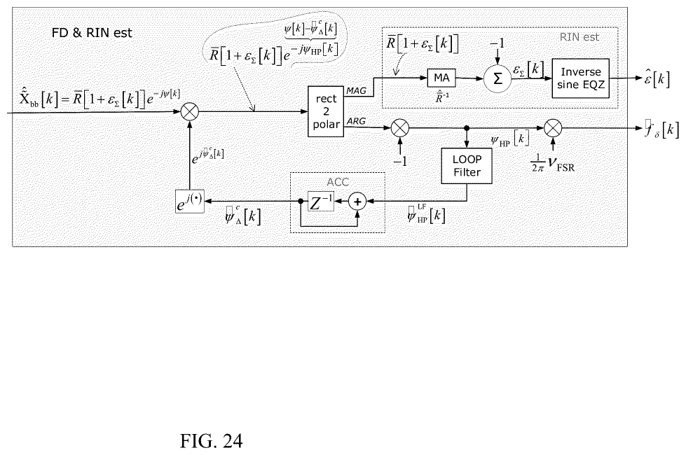

The ‘FD&RIN est’ module (see FIG. 24 Error! Reference source not found.) is the last one in the OFS processing chain, transducing the instant frequency and RIN-induced amplitude fluctuations into voltage waveforms.

The ‘FD&RIN est’ module is fed the MRC module and its outputs provide an estimate \hat{f}_{δ}(t)≡f̅_{τ}(t) of the FD, f_{δ}(t), and an estimate \hat{ε}(t) of ε(t), and of the RIN-induced amplitude fluctuations. The RIN estimate is optional, e.g., laser stabilization closed loop systems do not typically make use of RIN information, whereas some laser characterization systems may access the RIN information.

The block diagram also indicates optional signal processing to be performed on the estimated FD and RIN in a module performing ‘Upper Layer signal processing/Loop filtering’. As examples of upper layer signal processing, in a laser characterization instrument, the OFS subsystem FD and RIN outputs are spectrally analyzed by Power Spectral Density (PSD) estimators, the power spectra being displayed as laser characteristics. The FD PSD may be further used to synthesize the laser lineshape and measure the linewidths. In closed loop laser stabilization systems, the FD and optionally the RIN waveforms extracted by the OFS undergo loop filtering as part of feedback loops for stabilization of the FD and/or of the RIN.

One option for the internal structure of the ‘FD&RIN est’ module is to have it using a digital or analog PLL to filter out the baseband phase noise fluctuations due to the differential phase ψ_{Δ}^{c}(t), aka ‘interferometric differential bias wander’ which is a major low-frequency impairment affecting any interferometer. The disclosed PLL solution is adequate, given the fact that ψ_{Δ}^{c}(t) is a low-bandwidth baseband signal, whereas we are typically interested in the high-pass components of f̅_{τ}(t) excluding a noisy zone at the origin, which is afflicted by low-frequency noise such as 1/f noise due to thermal fluctuations of the frequency-selective system in the r-path.

Usage of the dual-quadrature hybrid enables lossless tracking of the interferometric bias wander.

The corresponding approach in the single-quadrature based IQDSH, is going to be more prone to some degradation by impairments but it is still feasible.

In FIG. 24 we disclosed the internal structure of the ‘FD&RIN est’ module having assumed digital signal processing (DSP). A corresponding analog structure for the ‘FD&RIN est’ module, functionally equivalent to the DSP-based structure depicted there, may be readily inferred by those skilled in the art. The signals in the description below are all sampled signals, indexed by discrete-time k. A Phase Locked Loop (PLL) structure is provided, using both quadratures (re&im parts) of \tilde{\hat{X}}_{bb}[k]. The PLL comprises a ‘phase detector’ subsystem, consisting of a complex multiplier and a complex-phase factor generator, e^{j( )} feeding it and the ‘rect2polar’ (rectangular-to-polar) conversion unit, representing its complex input signal in polar form, by separating the magnitude and argument (angle) on the two outputs marked MAG and ARG. The feedback path of the PLL comprises the Loop-Filter and Accumulator (ACC).

Note: in an analog implementation the ACC would be replaced by an analog Integrator.

The ‘rect2polar’ components, the alternative ARG extractor and the PLL loop filter are based on prior art components the internal structure of which will not be further described, but what matters is the operating principle of the entire disclosed ‘FD&RIN est’ and how the disclosed interconnection of components attains the target functionality in the current context, since this is a baseband complex-domain PLL unlike conventional passband PLLs.

The PLL essentially tracks the baseband differential phase wander ψ_{Δ}^{c}(typically up to about 0.1-1 kHz) effectively cancelling it, or at least suppressing most of it. Unfortunately, the PLL also suppresses the low-frequency components of the useful FD—this is a fundamental limitation in two-beam interferometric systems, which are unable to distinguish between low-frequency wander of the interferometric differential phase and useful signals to be sensed, which are encoded in the phase.

As for the ‘phase detector’ implementation, one solution is to have this component realized in DSP by extracting the ARG (angle) of the complex-signal \tilde{\hat{X}}_{bb}[k]e^{j\hat{ψ}}^{_{Δ}}^{^{c}}^{[k]}, then inverting the sign.

4. DGD/FSR Estimation in the prePM QDSH—Operating Near or at the Nulling Dither Frequency

An assumption initially tacitly made in analyses of prior art DI-based (DSH) as well as in our disclosed prePM QSDSH OFS system is that the Differential Group Delay (DGD), τ is fixed and known. Unfortunately, any fixed deviation (or time variation) in estimating the value of τ, used in formulating the FD estimate, would be mapped into a systematic (or random) error in the estimation or absolute calibration of the PSD of the FD. Henceforth, we model the more realistic situation by assigning slow time-dependency of the DGD τ(t) to model environmental fluctuations and their impact and disclose a novel estimation method for the DGD and a mitigation model for each fluctuation, which may in principle ‘push-the-performance-envelope’ by counteracting this major technical noise impairment.

In our prePM QPDSH OFs development heretofore we have selected the dither frequency to maximize the det-ACOR M_{PM}(t−τ)M_{PM}*(t) of the PM transfer factor.

This dither frequency, equal to half the FSR plus integer multiples of the FSR, is denoted ν_{d}^{pk} as it peaks the system response. As vastarts deviating from ν_{d}^{pk} the response starts diminishing.

When ν_{d} is taken as an integer multiple of the FSR, the system response nulls out, ideally, thus let us denote this setting of the dither frequency as the ‘nulling dither frequency’ , ν_{d}^{null}:

ψ_{d}|_{nulling}≡ω_{d}τ=0 mod 2π⇔ν_{d}^{null}=m·ν_{FSR}, m∈ [symbol] (4)

At this ‘nulling’ frequency, ν_{d}^{null}, a full the dithering RF wavelength fits into the differential optical path of the DI. Thus, the sinusoidal phase modulations propagating to the optical hybrids over the s- and r-paths arrive in phase. As the hybrid generates the phase difference between its two input ports, these two antipodal phase waveforms interfere destructively for ν_{d}=ν_{d}^{null}, eliciting a null response at the hybrid. However, the perfect destructive null cannot be continually retained when the DGD (and the FSR) slightly fluctuates (while the RF frequency stays stable at ν_{d}=ν_{d}^{null}) , as fluctuations in the DGD, τ cause the accumulated differential phase to slightly deviate from a multiple of 2π, thus the two RF modulated phase sinusoidal waveforms no not arrive in perfect phase most of the time, such that their subtraction at the hybrid generates small fluctuations around zero at the hybrid output. Monitoring these amplitude fluctuations at the hybrid ports (while assuming that the RF frequency is very stable) may indicate the deviation, relative to a multiple of 2π, of the accrued phase ψ_{d}=≡ω_{d}τ at the dither frequency ω_{d}=2πν_{d}^{null} (which is assumed stable). This then provides direct independent information about the DGD fluctuations, τ(t). This intuitive account of the principle of operation is quantified in the analysis to follow. This principle of operation enables an unprecedented cability to sense the fluctuations of the DGD τ(t) of the DI and even compensate for them in real-time, or at least to measure the mean fof the DI DGD and its inverse, the FSR (which are useful for absolute calibration of the estimated FD waveform in open-loop laser characterization systems).

The enabling condition for measuring τ(t) with high accuracy (without relying on estimating the optical frequency, which would have been a ‘chicken&egg’ problem since accurate measurement of the optical frequency requires stable and known τ) is not to rely on the stability of the optical frequency but to rather exploit the stability of the RF dither frequency ν_{d}, provided that such stability be provisioned (i.e., assuming a highly-accurate RF tunable oscillator is used for dithering, e.g. a GPS-assisted RF oscillator).

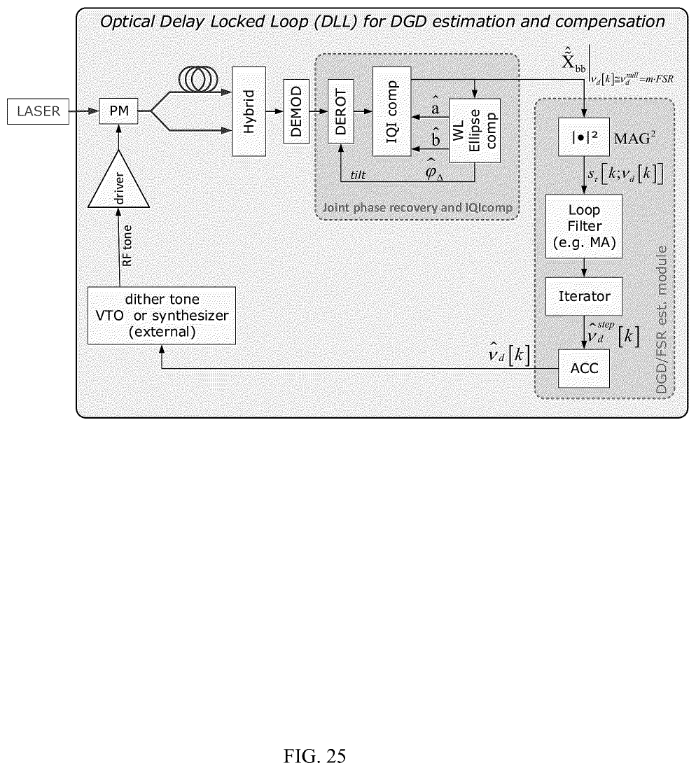

The DGD processing is conducted in a module referred to as ‘DGD/FSR est’ module generating s_{τ}(t; ν_{d}) as the absolute value of its input from the MRC, and from s_{τ}(t; ν_{d}) generating a control signal to a synthesizer or to a Voltage Tuned Oscillator (VTO) in order to increase or decrease its output instantaneous frequency. Thus, the ‘DGD/FSR est’ module in the top level diagram of FIG. 6 (FIG. 25 for the internal detail) acts as frequency detector in a Frequency Locked Loop (FLL) which makes the VTO frequency track the inverse of the DGD, τ(t), or at least track the slow variations in it, if unable to track the more rapid fluctuations.

This FLL may be specifically called here DLL (Delay Locked Loop). The ‘DGD/FSR est’ module acts as a DGD detector, and also includes an ‘iteration unit’ estimating and actuating increment/decrement steps to the external VTO or synthesizer, feeding the PM and closing the DLL loop around.

The DLL operates as follows: At initialization the dither frequency is set to our best preliminary estimate of ν_{d}^{null}, and the signal \tilde{\hat{X}}_{bb}|_{ν}_{_{d}}_{≅ν}_{_{d}}_{^{null}}_{=mν}_{_{FSR}} entering into the ‘DGD/FSR est’ module is processed by taking the modulus (MAG) of the input \tilde{\hat{X}}_{bb}(t) into the ‘DGD/FSR est’ , yielding s_{τ}≡|\tilde{\hat{X}}_{bb}|_{ν}_{_{d}}_{≅ν}_{_{d}}_{^{null}}_{=mν}_{_{FSR}}| as modeled in above. Next some loop filtering is applied, e.g. a short-time Moving Average (MA), intended to possibly smooth out the RIN fluctuations, ε_{Σ}(t), and in case we wish to estimate just the mean of τ_{δ}^{rel}(t), also intended to smooth out higher frequency fluctuations in τ_{δ}^{rel}(t). Then, the smoothed MAG, is followed by the ‘iteration unit’ working out the steps required to advance towards the minimum of the nonnegative function s_{τ}, which is known to have a minimum of zero in principle. Any of the numerous prior-art algorithms for one-dimensional optimization (minimization) may be used. E.g., a simple algorithm is to take a step and evaluate the empirical gradient and then take another step in the direction of the negative empirical gradient. As the function |τ_{δ}^{rel}(t)+ν_{d}^{rel}(t)| has a minimum of zero when to τ_{δ}^{rel}(t)+ν_{d}^{rel}(t)=0⇔ν_{d}^{rel}(t)=−τ_{δ}^{rel}(t) the algorithm will attempt tracking that value in real time.

Note 1: It is possible to also use |τ_{δ}^{rel}(t)+ν_{d}^{rel}(t)| as optimization target, and iteratively solving a formal optimization problem in one dimension,

$${min}_{{v}_{d} ( t )} {q}_{τ} [ t ; {v}_{d} ( t ) ] ≡ {\vert {\hat{\tilde{X}}}_{b b} ( t ) {\vert}_{{v}_{d} ≅ {v}_{d}^{null} = m {v}_{FSR}} \vert}^{2} \qquad ( 5 )$$

Note 2: Another possibility is to feedback not to ν_{d}^{rel}(t) but directly to τ_{δ}^{rel}(t), e.g., by inserting into either the r- or s-paths of the DI, a means to vary the group delay (two-sided, both increase and decrease relative to a mean value), such as a PZT fiber stretcher or other means of inducing mechanical strain, and to actuate the variable optical delay means by increments/decrements from the ‘iteration unit’ of the ‘DGD/FSR est’ module. The two methods may be combined, actuating both the variable optical delay means and the VTO generating the PM dither frequency.

To recap the principle of operation, the innovative preMOD structure enables, by switching the dither frequency in the vicinity of a null of the response, to the sense the product ψ_{d}(t)=2πν_{d}(t)τ(t) of the DGD and of the dither frequency fluctuations. Simple calculus shows that the fluctuations of ψ_{d}(t) are essentially the fluctuations of the sum τ_{δ}^{rel}(t)+ν_{d}^{rel}(t). If the dither oscillator jitter-induced random fluctuations in ν_{d}^{rel}(t) are at ultra-low level (e.g., if we use high purity dither source, e.g. a GPS-stabilized oscillator), we may then induce intentional variations in ν_{d}^{rel}(t) (by means of a VTO) to track and cancel out, in real time the fluctuations τ_{δ}^{rel}(t) of the DGD, in effect forming the DLL feedback system. The net effect is that ψ_{d}(t) is stabilized, which takes out yet another source of impairment, and also enables absolute calibration of the system.

### Dual Frequency Operation—Sensing the DGD and Simultaneously Sensing FD (and RIN)

The DLL disclosed in the last section ensures that the dither frequency is actuated to small fluctuations counteracting the DGD fluctuations such that the dephasing ψ_{d}(t) is stabilized around the null frequency. However, to make an FD (and RIN measurement) one needs to switch the dither frequency away from the multiple of the FSR, whereat the received dither tone amplitude response is weak (where we run our DLL operation) and operate in the vicinity of ν_{d}^{peak}, whereat the response is strong. But once the dither frequency is shifted away from the vicinity of the nulling frequency, the DLL ceases to be functional. The solution is to use a pair of dither frequencies at once, the first one minimizing the response for the purpose of DGD sensing by the PLL, namely ν_{d}^{near-null}(t)≅m·ν_{FSR}, nominally at integer multiple of the FSR (with small deviations thereof applied by the DLL VTO) as already disclosed in the DLL disclosure above, and the second frequency maximizing or nearly maximizing the response, namely

$${v}_{d}^{near - peak} ( t ) ≅ ( m \pm \frac{1}{2} ) \cdot {v}_{FSR} ,$$

or if possible

$${v}_{d}^{peak} ( t ) = ( m \pm \frac{1}{2} ) \cdot {v}_{FSR} ,$$

such that a strong response is obtained for the demodulated amplitude at this second dither frequency. It is on this second frequency we perform our FD (and optionally RIN) sensing, in parallel to the DGD-sensing (the DLL operation) performed on the first frequency, ν_{d}^{near-null}(t)≅m·ν_{FSR}. But we should transfer the frequency fluctuations of ν_{d}^{near-null}(t), to the near-peak frequency. Thus, the fluctuations of the second frequency should be tracking the fluctuations of the first frequency (which may be ensured by a frequency offset VTO or a synthesizer output both frequencies such that

$${v}_{d}^{near - peak} ( t ) - {v}_{d}^{near - null} ( t ) ≅ ( m + \frac{1}{2} ) \cdot {v}_{FSR} - m \cdot {v}_{FSR} = \frac{1}{2} {v}_{FSR} + negligible - fluctuating - deviations . \qquad ( 6 )$$

thus the two frequencies should be slightly wobbling back and forth along the frequency axis, whereas the near-peak frequency maintains (as much as feasible) fixed distance

$$\frac{1}{2} {v}_{FSR}$$

relative to the near-null frequency. The initiator of ‘wobbling’ here is the ‘near-null’ frequency, as driven by the DLL , such that its wobbling is opposite to that of the DGD fluctuations. Then the ‘near-peak’ frequency tracks the same wobbling as the ‘near-null’ frequency and that yields a cancellation of the DGD fluctuations impairment for the operational sensing of FD (and optionally RIN) over the near-peak frequency subcarrier.

### Optical Length Sensor (OLS) Based on Our Disclosed OFS

In a different application, the system may be used as an optical length sensor (for the difference of the two DI paths) by measuring the frequency at the output the VTO of the DLL (or by precision calibrating the driving input of the VTO). Indirectly, various quantities which transduce into optical length changes, such as temperature, strain, acoustic vibrations, may also be sensed. The difference relative to conventional interferometry is that here we do not operate not on a wavelength length scale but rather on a multiwavelength scale. The two methods may be combined in an OFS-based Optical Length Sensor (OLS) tracking both the ψ_{Δ}^{c}(t) phase (on the wavelength scale) using the PLL technique and the relative DGD variation τ_{δ}^{rel}(t) (calibrated in optical length units by multiplying by c), thus getting access to both length scales.

### Phase-preMOD Single-Quadrature Delayed Self-Heterodyne Interferometer

In the preMOD 1QDSH OFS, based on the single-quadrature hybrid, just a single quadrature, say the Q-quadrature one, is sensed. We shall work out here the model for the single received quadrature, Q(t), and infer the modifications required to the opto-electronic system and to the signal processing relative to the earlier treated dual-quadrature operation. The general signal processing structure disclosed in FIG. 6 for dual-quadrature processing is applicable to the current case of single-quadrature, albeit with some adaptations and modifications (for single-quadrature hybrid, the Signal Processor variant of FIG. 7 is presently disclosed). In particular, the complex-DEMOD bank is usable since around the negative complex subcarriers of the received bandpass signal there is redundant information in the negative frequency Hermitian mirror images, which is worth extracting.

The signal processing structure and/or additional needed opto-electronic pre-processing is consistent with the model of the single quadrature reception process, as developed below.

The bottom-line conclusion from the model is surprising: Despite giving up on one quadrature, the full information is available in the single detected quadrature, as needed to estimate and mitigate the interferometric differential bias phase wander, ψ_{Δ}^{c}(t), and to extract the FD and RIN information. The signal processing methodology is then outlined, teaching how to extract the full information, leveraging the signal processor structure for dual-quadrature and adapting it to the single quadrature case.

### Post-1Q-Hybrid Signal Processing for Mitigation of the Interferometric Phase Wander

We now disclose a method of jointly processing the MRC signals obtained from the harmonics of order ±1 and of order ±2 respectively, after demodulation and derotation of the single-quadrature electrical output, such as to estimate ψ_{Δ}^{c}(t), enabling to compensate for it and operate the 1Q DQSH without requiring active control of the interferometric phase bias wander. Our disclosed solution to this challenge is to not normalize by the two weights at all, but rather form the complex statistic, −j{X_{bb}^{MRC[±1]}(t)−Xb , X_{bb}^{MRC[±2]}(t)}, the trajectory of which is no longer a circle but it is rather an ellipse in the complex plane (where in the second line below the RIN-term was neglected):

$$\begin{matrix}{{\tilde{X}}^{⎴}}_{bb}^{1 Q H} ( t ) = - j \{ {X}_{b b}^{MRC [ \pm 1 ]} ( t ) - {X}_{bb}^{MRC [ \pm 2 ]} ( t ) \} \\ = [ 1 + {ε}_{Σ} ( t ) ] \overline{R} \cdot \{ {J}_{1} ( 2 β ) cos ψ ( t ) - j {J}_{2} ( 2 β ) sin ψ ( t ) \} \\ ≅ {\underbrace{\overline{R} {J}_{1} ( 2 β )}}_{a} cos ψ ( t ) - j {\underbrace{\overline{R} {J}_{2} ( 2 β )}}_{b} sin ψ ( t )\end{matrix} \qquad ( 7 )$$

where the superscript ^{1QH}stands for single-quadrature hybrid, and the trapezoidal hat denotes that this is an IQ-imbalanced estimate.

We are now in a position to adapt our ellipse estimation algorithm (as disclosed for the ‘WL ellipse est’ module) in order to estimate the ellipse semi-axes, a, b which may be used as the normalizing factors to generate the ideal unit circle e^{-jψ(t)} just as above. A second approach is to continue from this point on just as in the dual-quadrature case, passing the signal [symbol] _{bb}^{1Q}(t) through the IQI-comp (the WL-equalizer), in order to generate the ‘perfect’ circle. The advantage of this approach is that any possible ellipse tilt, as generated from uncompensated IQ-imbalance is also taken out by the IQI-comp (assisted by the ‘WL-ellipse est’) module.

### Signal Processing Structure in the Case of Single-Quadrature Operation

FIG. 7 describes the signal processing structure for the single-quadrature preMOD QDSH OFS. This diagram may be compared with the one of FIG. 6 for the signal processing structure for the dual-quadrature preMOD QDSH OFS.

In FIG. 7, for the single-quadrature case, the DEMOD and DEROT banks now demodulate and derotate just the orders ±1 and ±2 (i.e., there are four parallel demodulators and four parallel derotators in the respective modules. The ‘MRC diversity for orders[±1, ±2] combines the ±1-orders with equal weights, say ½, to generate the signal X_{bb}^{MRC[±1]}(t) and in parallel combines the ±1-orders with equal weights, say ½, to generate the signal X_{bb}^{MRC[±2]}(t). These two signals (which may be generally complex-valued) are subtracted and their difference is −90° rotated as indicated above and shown in the figure, generating the hybrid sufficient statistic [symbol] _{bb}^{1Q}(t) (note: actually, the rotation by 90 deg is not essential, it is more of conceptual value in the analysis, as the following ellipse derotator output is invariant to it). Next, [symbol] _{bb}^{1Q}(t) is compensated in the WL-ellipse algorithm which follows the WL-equalizer structure already disclosed within the IQI-comp module (FIG. 22) Error! Reference source not found.in the dual-quadrature signal processing). The ellipse compensation algorithm (its conversion into a complex-plane circle) is performed using the eccentricity parameters, â, \hat{b} as estimated in the ‘WL-ellipse est’ module in the top-level block-diagram of FIG. 7. The output of the ‘WL-ellipse-comp’ module is fed into back-end processing, identical to that conducted for the dual-quadrature hybrid in FIG. 24: The ‘rect2pol’ module extracts the phase argument (ARG) and the absolute value (MAG) of its complex input, which are finally processed in the ‘FD est’ and ‘RIN est’ modules. These two modules are identical to those disclosed in FIG. 6 for the case of using the dual-quadrature hybrid. Just as in that case modules ‘DGD/FSR est’ and ‘Upper Layer signal processing/LOOP FILTERING’ may be optionally used.

To recap, the basis for this method of compensating for ‘interferometric carrier phase wander entirely in the signal processing is the diversity afforded by observing both harmonics of order[±1] and of order[±2]. These two harmonics come out, in the case of single-quadrature hybrid’ proportional to j cos ψ(t), sin ψ(t) with generally two different proportionality constants, thus the information about ψ(t) is jointly available in the dominant subcarriers of order[±1] and order[±2], and a phase factor e^{-jψ(t)} may then be extracted using ellipse compensation techniques.

The Signal to Noise Ratio (SNR) of this method is expected to be higher than in active compensation of the ‘interferometric carrier phase wander’, since we now have access to redundant information in the second harmonic subcarrier, which is ignored in the conventional method. Nevertheless, since we have not performed MRC combining order[±1 ] with order[±2], as in the single-quadrature case, the SNR for the single-quadrature based method outlined in FIG. 7 is expected to be lower than the SNR for the dual-quadrature based method outlined in FIG. 6.

We finally note that all the schemes disclosed in this invention are Heterodyne rather homodyne scheme. In a Homodyne scheme, the single-quadrature signal, Q(t) may occasionally fade to zero. In the Heterodyne schemes, since the FM dither modulation is large enough, the signal rapidly performs a large phase swing and does not fade totally—actually, as the first harmonic component fades the energy mostly gets redistributed into the second harmonic component and vice-versa. There may be slight fading due to the amplitudes of the first and second harmonics being different, but overall the heterodyne signal does not experience deep notches, enabling the signal-processing based methodology disclosed of FIG. 7 for the single-quadrature hybrid case.

To recap, this embodiment provides ‘interferometric differential phase bias tracking’ without active phase modulation, all in the signal processing. In the next section we disclose a more conventional alternative approach, actively actuating the phase tracking in the electro-optic domain.

### Application of the Single-Quadrature Signal Processor to Processing the Electrical Output of the Single-Ended Combiner+PD of a Delay or Two-Beam Interferometer

We now disclose that the signal processor depicted in FIG. 7, may also be used, as is, to process the electrical output of a single-PD photo-detecting the superposition of the two paths of a delay interferometer. The reason this is possible is that the single-ended PD combiner just generates three components: (i) The absolute square of the field outgoing from the s-path. (ii) The absolute square of the field outgoing from the r-path. (iii) The cross-term (beating, interference) term between the s-path and r-paths outputs of the DI-IDT. This cross-term is indistinguishable, signalwise, from the output of an 1QH (single-quadrature-hybrid). Moreover, the direct-detection components (i) and (ii) are centered around baseband, hence are blocked by the heterodyne processing performed in the single-quadrature signal processor disclosed in FIG. 7 Error! Reference source not found. Thus, this signal processor would generate essentially the same signal, when fed by a single-ended combiner+PD, as it does when fed by a 1QH, as in FIG. 7.

The difference is that in the case of single-ended combiner+PD, the disclosed single-quadrature processing would yield a somewhat noisier signal, since the amplitude of the beat-term in a single-ended combiner+PD is half that generated by the 1QH (under indentical input conditions).

The significance of this disclosed signal processing method for single-PD based interferometers is substantial, as in principle any single-PD based interferometer may be retrofitted with the signal processor of FIG. 7 or equivalent means to perform essentially equivalent signal processing. We reiterate that a key quality of our signal processor of FIG. 7 is that its processing ensure mitigation fading occurring in single-ended-PD-based or single-quadrature interferometers. This fading is due to the interferometric differential phase wander. The principle of mitigating the interferometric bias fading is based on the diversity of the fadings of the first and second harmonics in the heterodyne detection. Essentially, when the first harmonic goes into fading the second harmonic fades less, and viceversa. Thus, joint processing of both harmonics, as practiced in our disclosed signal processor of FIG. 7, mitigates this fading.

### Slow Extremum Seeking Control Electro-Optically to Mitigate Differential Phase Wander in IQ OFS

We propose an alternative mitigation embodiment for the slow interferometric bias phase wander based on the conventional actuation in-the-electro-optic domain approach. To that end, to design the actuation and sensing means, and close the feedback loop we disclose adopting the extremum-seeking control framework for both estimation and tracking control of ψ_{Δ}^{c}(t). As for the physical means to actuate increments to ψ_{Δ}^{c}(t), we disclose, for single-quadrature systems, applying one of the following alternative modifications to our disclosed block diagrams: provide for modulations by low-voltage low-frequency dithering sinusoids within the two DI paths (specific to this task of controlling the optical carrier differential phase, ψ_{Δ}^{c}(t), distinct from the high-frequency dither applied to the main dithering modulators in our embodiments).

It suffices to use a model of the passband signals, either the modulation around the first-order subcarrier, at frequency ν_{d} or the second order subcarrier at frequency 2ν_{d}. Around these subcarrier, if slow dither is applied in the electro-optic domain, sidebands close to the respect carriers will appear. The amplitudes of these weak sidebands, appearing close to the subcarriers at ν_{d} or 2ν_{d} are indicative of the slow interferometric phase bias ψ_{Δ}^{c}(t).

When the 1QH (single-quadrature hybrid) is used, in order to perform compensation (derotation) of the differential phase wander, ψ_{Δ}^{c}(t) may be required to have it estimated first, subsequently actuate opposite sign increments of appropriate magnitudes to the differential phase. In the current context, we disclose equipping the dual-output modulator module of our OFS systems with phase and/or amplitude actuation capabilities at slow rate and applying to the phase/amplitude actuation electrical ports signals consisting of control increments and of sinusoidal dithers. The need for slow, weak phase dither perturbations being applied in at least one of the two paths (s- and/or r-) is quite evident—it is needed for the extremum-seeking technique, since the differential phase is the control target to track. Thus, sinusoidal dithering of the differential phase between the s- and r-paths should be actuated (to enable estimation of the differential phase by extremum seeking technique) and it is also needed to actuate arbitrary differential phase increments onto at least one of the two outputs of the dual-output pre-Modulator (preMOD). The actuation of ψ_{Δ}^{c}(t) requires inserting slow phase modulation dithers in the two DI paths, and providing for additional slow processing at the receiver.

In more detail (FIG. 5):
i. Insert a slow phase modulator (e.g. thermo-optic) in just one of the paths, be it the r-path or the s-path), and have it driven by a low-voltage low-frequency dithering sinusoid.
ii. Insert a pair of phase modulators (e.g. thermo-optic) in both the s- and r-paths) and have them push-pull driven by a pair of antipodal (with relative phase of 180°) low-voltage low-frequency dithering sinusoids.
iii. Provide means of generating the low-frequency low-peak phase dithering modulations to one or both outputs of the high-speed dithering 2-way-split main modulator. The objective is to apply additive phaseshift to either one of the split outputs of the modulator or to both output (in which case we want the phaseshifts of the s- and r-paths to have opposite signs, preferably be antipodal).

To actuate slow, weak dithering of the phases the signals injected into the s- and r-paths, we disclose equipping at least one of the two output ports of the variable 1:2 splitter with slow, weak optical phase modulator(s), such as Thermo-Optic PM(s), as shown in FIG. 5, and apply weak push-pull (antipodal) sinusoidal drive voltage(s) to the two slow PMs, in case two such PMs are used in the two output arms of the variable splitter, or just have a single PM inserted into one of the output arms of the preMOD. It is more efficient to have a pair of PMs, one in each of the two arms, but it is also sufficient to asymmetrically have a single PM inserted into just one of the two output arms at the expense of 3 dB loss in extremum-secking signal to noise ratio. Weak sinusoidal or multitone phase dithers are injected into the single slow PM or into the pair of PMs (upon using a PM pair, the phase dither drives of the two PMs carry antipodal multitone or sinusoidal waveforms).

In addition, we may apply arbitrary phase increment(s) to the drivers single PM or pair of PMs, as commanded by the extremum-seeking controller (again in antiphase, in case two PMs are used on the two outputs). These phase increments are used to compensate for the differential phase (the lock-in detection of the actuated sinusoidal phase dither enables estimating the needed phase increments to apply in order to converge and continually track the differential phase).

Once the means to actuate a phase increment to ψ_{Δ}^{c}(t) is provided as above, the control system for stabilizing ψ_{Δ}^{c}(t) follows the extremum-seeking control paradigm taught in [2][3], with the drive voltage on the modulator inducing an optical phaseshift βₐ sin 2πνₐt+ψ_{Δ}^{a}(t). The extremum-seeking processing on the receiver side consists of monitoring the receiver electrical output by means of a synchronous detector (demodulator) driven by reference proportional to sin 2πνₐt. The resulting signal is proportional to the derivative of the sinusoidal transfer characteristic, thus enabling to actuate the low-frequency component of ψ_{Δ}^{c}(t) to an extremum (minimum or maximum) of the nonlinear transfer characteristic (be it cos ψ_{Δ}^{c} for sin ψ_{Δ}^{c}) by following a gradient-descent algorithm.

This solution for stabilizing our disclosed heterodyne single-quadrature OFS systems by mitigating the random bias variation of ψ_{Δ}^{c}(t), may be compared with the treatment of the random phase bias variation ψ_{Δ}^{c}(t) in our disclosed dual-quadrature OFS systems. The key distinction between the two system types is that the sufficient statistic for our dual-quadrature OFS features ψ_{Δ}^{c}(t) in the complex-exponent, \tilde{X}_{bb}^{2quadrant}(t)=[1+ε_{Σ}(t)]e^{-j[2πf̅}^{_{τ}}^{(t)+ψ}^{_{Δ}}^{^{c}}^{(t)]} rather than in the argument of a sine or cosine function

[1+ε_{Σ}(t)]sin[2πf̅_{τ}(t)+ψ_{Δ}^{c}(t)], [1+ε_{Σ}(t)]cos[2πf̅_{τ}(t)+ψ_{Δ}^{c}(t)]. (8)

Thus, in the dual-quadrature solution there is no fading (as the complex exponent rotates in a complex plane circle (apart from tiny RIN induced deviations), thus and no distortion and no variations dependent on the instant value of the bias—all that occurs is that the desired complex component [1+ε_{Σ}(t)]e^{j2πf̅}^{_{τ}}^{(t)}, which approximately (ignoring the RIN fluctuations) moves on an arc in the complex plane , gets rotated by the slowly varying ‘rotor’ factor e^{-jψ}^{_{Δ}}^{^{c}}^{(t)}, which we taught the compensation of by the complex-PLL.

### Dual-Output Pre-Modulator Implemented as MZM with Push-Pull Drive

In our most generic disclosure we introduced the preMOD as a generic Single-Input Dual-Output (SIDO) modulation system. Heretofore we only introduced a special case of the generic SIDO preMOD, namely the PM-based dual-output preMOD (see the top preMOD modulation option in FIG. 1 section (b) consisting of a PM followed by a 1:2 splitter. We now disclose another option for the SIDO preMOD, namely having the PM consist of a push-pull dual output Mach Zehnder Modulator (MZM) (the second option from the top in the preMOD embodiments of FIG. 1 section (b).

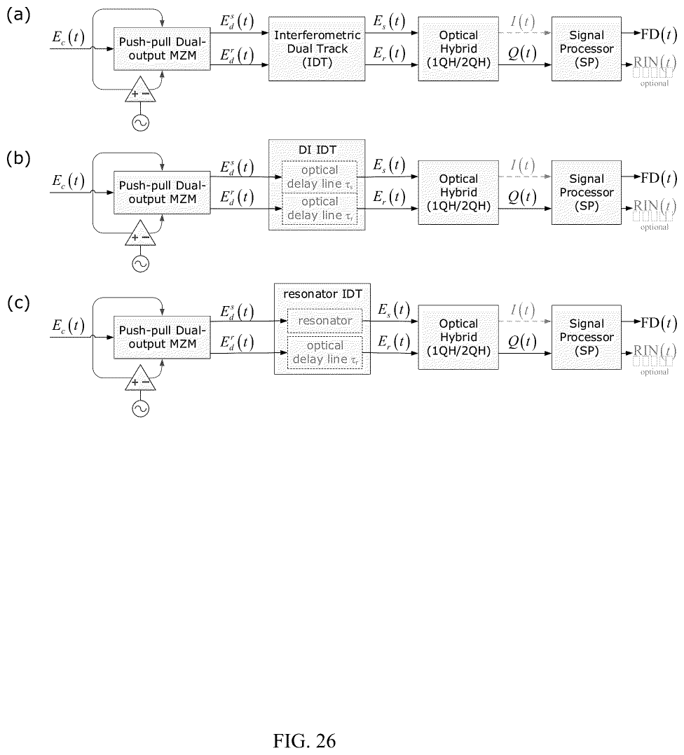

Our most generic preMOD QSH system of FIG. 2 is depicted in FIG. 26 with its generic preMOD replaced by the dual-output push-pull MZM. This OFS system, referred to as preMZM QSH, may further be specialized to generate new feasible sub-embodiments by cascading the preMZM with various combinations of the options in FIG. 1 sections (c) and (d), for the IDT and/or for the Hybrid.

These disclosed OFS systems function similarly to our corresponding OFS based on the PM based embodiments of the preMOD, as indicated by the modeling conducted above.

### Vestigial SideBand (VSB) Dithering IQ Modulation Using a Pair of ‘Children’ MZMs

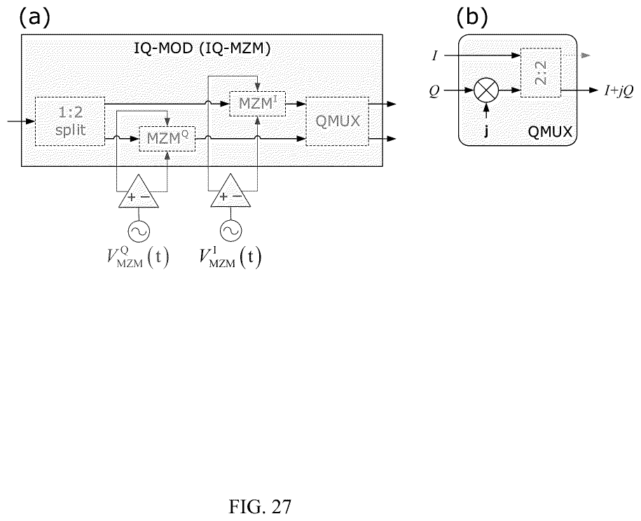

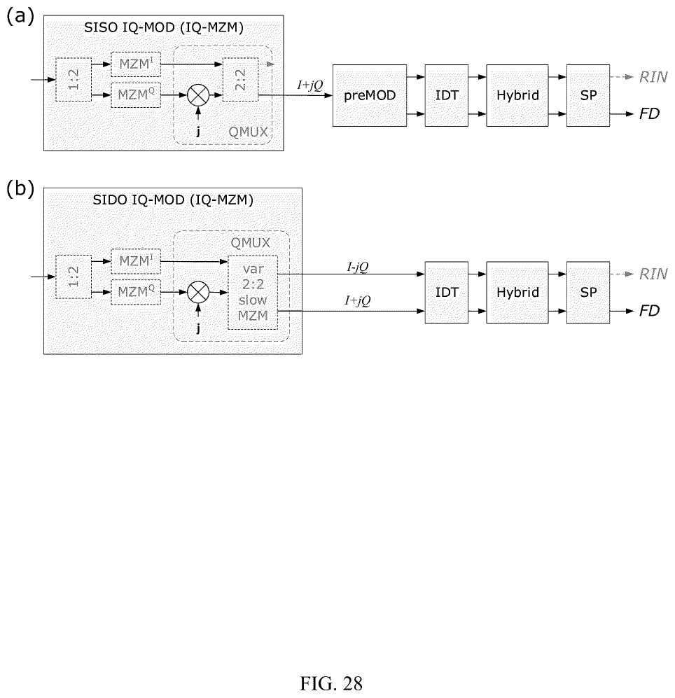

Our final disclosed option for the SIDO preMOD is an IQ modulator, adapted to be endowed with two optical outputs. Let us first review the structure and model of an IQ modulator (IQ-MOD), FIG. 27, based on using a pair of MZMs (the IQ-MZM). The IQ-MZM splits light 50:50 to two ‘children’ MZMs, both with outputs taken at, say, the bottom output port optically combining the two children MZMs in quadrature. The quadrature linear combination of the two children MZMs may be implemented by coherently combining the two MZMs with one of the arms having an extra ±j phaseshift. The quadrature multiplexing device is referred to in FIG. 27 as QMUX. The QMUX has two output ports in principle, if it uses a 2:2 port internally, but typically the light from one of the two output ports of the QMUX (the upper output port in FIG. 28 section (a)) discarded, in which case the resulting IQ-MZM is a SISO device. In our context we would use the single output port of the SISO IQ-MZM having it fed into our disclosed OFS chain (the preMOD, IDT, Hybrid and SP as in FIG. 1). The problem with the SISO IQ-MZM implementation is that half the light power is lost. Our preferred embodiment, however, is not the SISO-IQ-MZM but rather a SIDO-IQ-MZM as shown in FIG. 28 section (b), combining the two children MZMs by means of a variable 2:2. The two outputs are complex conjugates of each other (up to splitting constants when the var2:2 is not 50-50).

To see the advantage of the SIDO IQ-MZM based embodiments over using the other options we carlier disclosed for the dual-output preMOD, we work out a detailed analysis of the IQ-MZM both in small signal (as usually done) but also for strong dithering drives, which is the case we disclose here.

To preview the intent of the derivation, it is well known that an IQ-MOD may be used as a Single-SideBand (SSB) optical tone generator, when it is weakly driven by sinusoidal electrical drives mutually at 90° phase. But the resulting optical tone would be too weak for our purposes.

We rather disclose driving the IQ-MOD at sufficiently strong RF levels to optimize the modulation index of the two children MZM such as a strong Vestigial SideBand (VSB) asymmetric sparse spectrum is generated. When the DIDO IQ-MZM with conjugate outputs is used, not only are the VSB spectral lines at large modulation index (which improves the SNR of our OFS system) but also the optical levels are strong as the DIDO

IQ-MZM is 3 dB more optically efficient of the SISO IQ-MZM which discards one output port.

We shall also see that the generated spectrum is sparse with its spectral lines separated at four times the dithering frequency, which enables broadband tuning of spectral lines, for example the offset sideband implementations of FIG. 9.

### Modeling

In this embodiment we disclose using both output ports of a dual-output IQ-MZM, with its two children MZMs driven by two sinusoidal electrical signals in quadrature, feeding the two optical output ports of the dual-output IQ-MZM into the two inputs of the gauged optical 2:2 port, which may consist of two uncoupled s- and r-SISO optical systems. In particular, the first sub-embodiment we shall model is the case of using a DI, i.e., the top IQ-MZM output port is fed into a longer optical delay line whereas the bot-IQ-MZM output is fed into the reference path (r-path) optical waveguide or fiber, and the two s- and r-optical paths of different optical lengths are fed into the two inputs of a dual-quadrature or single-quadrature optical hybrid.

### Preferred preMOD Embodiment: SIDO IQ-MZM with Conjugate Outputs, Hard-Driven to VSB

When a PM is used for the dithering pre-modulation we have seen that it is advantageous to follow the PM by a variable 1:2 splitter rather than a fixed 50-50 2:2 port, this in order to maximize the useful signal at the hybrid output. Here we disclose a similar option leading to a preferred embodiment of our dual-output IQ-MZM (FIG. 28 section (b)) . (The MZM-Q output is phase-shifted by ±90° , i.e. its following interconnecting waveguide is made ¼ or ¾ of a wavelength longer or shorter than the waveguide at the output of the MZM-I, with both thesc waveguides leading to a 2:2 combiner. The QMUX is now implemented to comprise a slow variable MZM, which may be set to arbitrary splitting ratio by the quasi-statically applying an antipodal pair of actuation voltages to the phase modulators wrapped around the top and bottom waveguides in the two arms of the slow MZM. In addition, we provision for optionally varying the modulation depth of the high-speed sinusoidal tones applied to the two children MZMs, which is another degree of freedom available to shape the output response, e.g. maintain high extinction of certain spectral components which come out as null in the ideal analysis.

Slow amplitude dithering extremum seeking control to mitigate differential phase wander

Having discussed several preMOD types (dual-output PM, dual-output push-pull MZM, IQ-mod) evidently either of these SIDO modulators may be used to feed the s- and r-paths of the interferometric section of any of our OFS embodiments, and be terminated with either single-quadrature or dual-quadrature hybrid. When single quadrature hybrid is used, (in the context of the dual-output PM based embodiments) there is need to track the slow differential bias phase wander, and one of the two methods provided to that end consisted of active slow phase dithering controls provided in either the s- or r-paths or in both. When the optical hybrid operates with a single-quadrature (1QH), we have seen that unless the differential phase wander is actively compensated for ahead of the self-coherent coherent detection in the hybrid then irreversible distortion and fading occur. Thus, in this case there is need for active phase increment actuation ahead of the photo-detection in the hybrid. This section complements that section on the estimation and tracking the optical carrier differential phase wander impairment in order to mitigate it in order to have our disclosed OFS systems function optimally, extending that approach to the other types of SIDO modulators and also adopting amplitude slow dithers in licu of or in addition to the phase slow dithers.

When the optical hybrid operates with dual-quadrature (IQH) (which is the preferred embodiment), compensation of the differential phase may be performed in the post-detection processing without incurring irreversible distortion and fading.

Further to applying slow, weak phase dither, as discussed above, it is optional to also apply slow, weak amplitude dither perturbations onto at least one of the two paths (the preMOD output(s) feeding the s- and/or r-paths), preferably amplitude dither should be induced onto both output 14 signals. The rationale is that when the differential phase between the s- and r-paths is properly compensated, the RIN-originated amplitude fluctuations are suppressed at the hybrid output (be it 1QH or IQH) to first-order. Else, a term bearing the amplitude fluctuation appears at the hybrid output, proportional to the sine of the differential phase. When amplitude dither is applied this term arising at the hybrid output will thus be sinusoidal with amplitude proportional to the sine of the differential phase. Thus, push-pull injection of amplitude dithers in the two arms and corresponding coherent (lock-in) electrical demodulation of this amplitude-dither term at the hybrid output (with reference at the same frequency as used for actuating the dithering of amplitude) provides an estimate of the target differential phase. In fact, one may estimate the differential phase wander by either using phase dithering or by using amplitude dithering, but since the slow PMs are needed anyway for actuation of the phase increments in case the hybrid is of the single-quadrature type, we should then have the PMs in any case and we might as well also apply phase dithers onto them. The further application of amplitude dithers is then optional.

Applying both phase dithers and amplitude dithers provides an SNR advantage in the differential phase estimation as we may perform linear combining of the estimates in the post-detection extremum-seeking processing.

To perform the amplitude dithering we disclose specific configurations for amplitude dithering requiring no new optical hardware, just additional drive signals injection, in case the high-speed preMOD consists of:
(i) PM+1:2variable-splitter
(ii) dual-drive variable-MZM
(iii) dual-output-IQ-MZM with 1:2 variable IQ-combiner

For preMOD of types (i) or (ii) amplitude is dithered by superposing onto the drive signals of the 1:2 splitter slow, weak, slow amplitude dithers by adding in sinusoidal signal(s) atop the quasi-DC splitting ratio control voltages of the variable 1:2 splitter.

In particular, when the variable 1:2 splitter is implemented as a slowly tunable dual-drive dual-output MZM, it suffices to additively inject additional electrical signals into the two electrical drive ports of the MZM (atop the antipodal push-pull DC drive voltages used to select the splitting ratio of the slow MZM in its original variable splitter functionality). Let the two slow-splitter-MZM drive voltages be denoted Vₛₚₗₜ^{top}(t), Vₛₚₗₜ^{bot}(t) . Originally, just for the splitting task we splt take [Vₛₚₗₜ^{top}(t), Vₛₚₗₜ^{bot}(t)]=[Vₛₚₗₜ, −Vₛₚₗₜ] where the DC voltage Vₛₚₗₜ controls the splitting ratio.

Now, to actuate slow, weak amplitude dithering of the amplitudes of the signals injected into the s- and r-paths, we apply to the dual drive electrodes the following voltage waveforms resulting in a slow sinusoidal variation of the splitting ratio

[Vₛₚₗₜ^{top}(t), Vₛₚₗₜ^{bot}(t)]=[Vₛₚₗₜ+V_{ad} sin 2πν_{ad}t, −(Vₛₚₗₜ+V_{ad} sin 2πν_{ad}t)] (9)

where the superscript adstands for amplitude dither.

This discussion suggests adopting dual-quadrature hybrid based systems, rather than single-quadrature ones, for our implementations at large. Nevertheless, if a single-quadrature hybrid is to be used, the extremum-seeking control solutions outlined above may yield adequate performance, depending on the specific designs.

### preModulated Quadrature-Resonant-Self-Heterodyne (preMOD QRSH) OFS

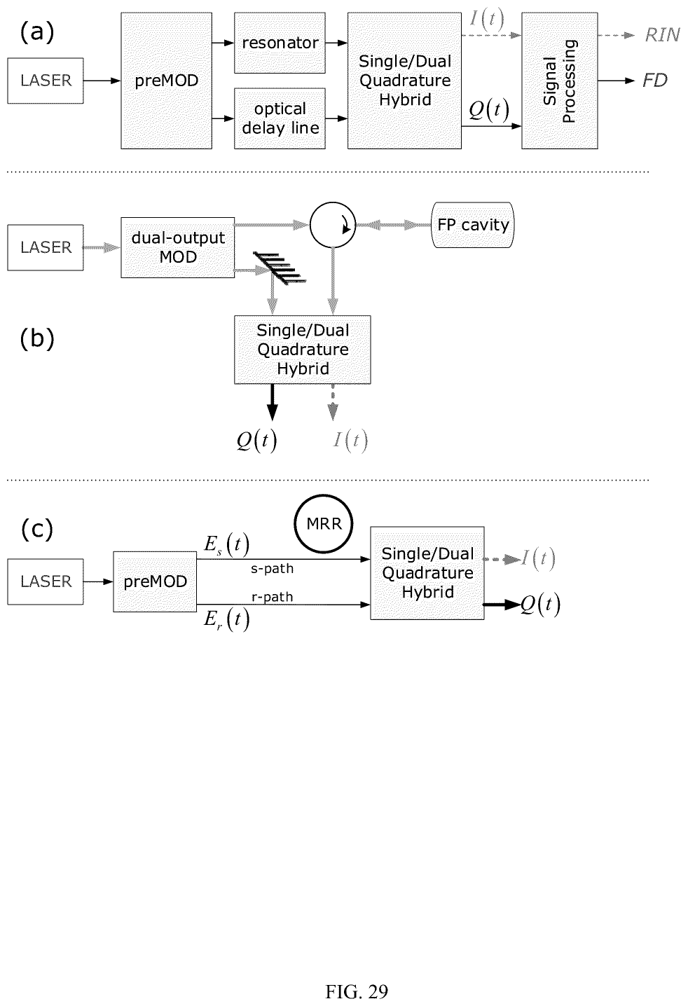

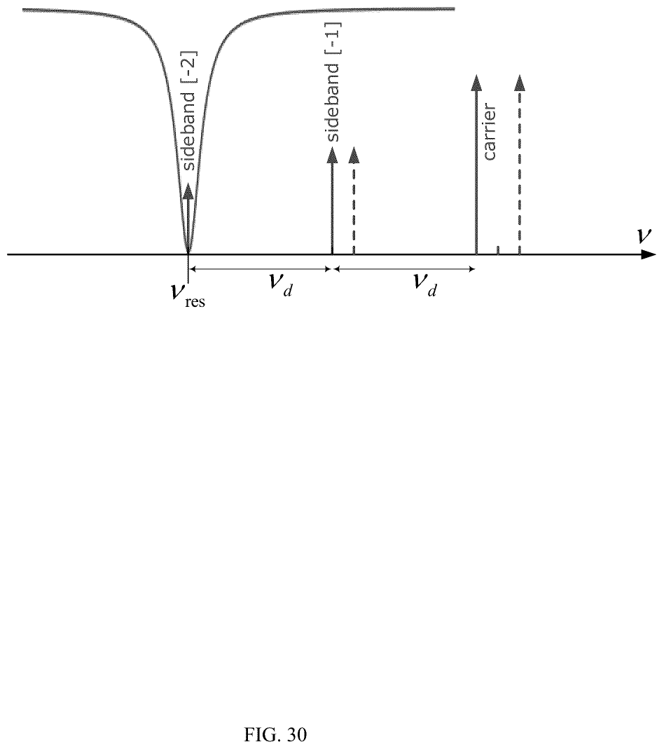

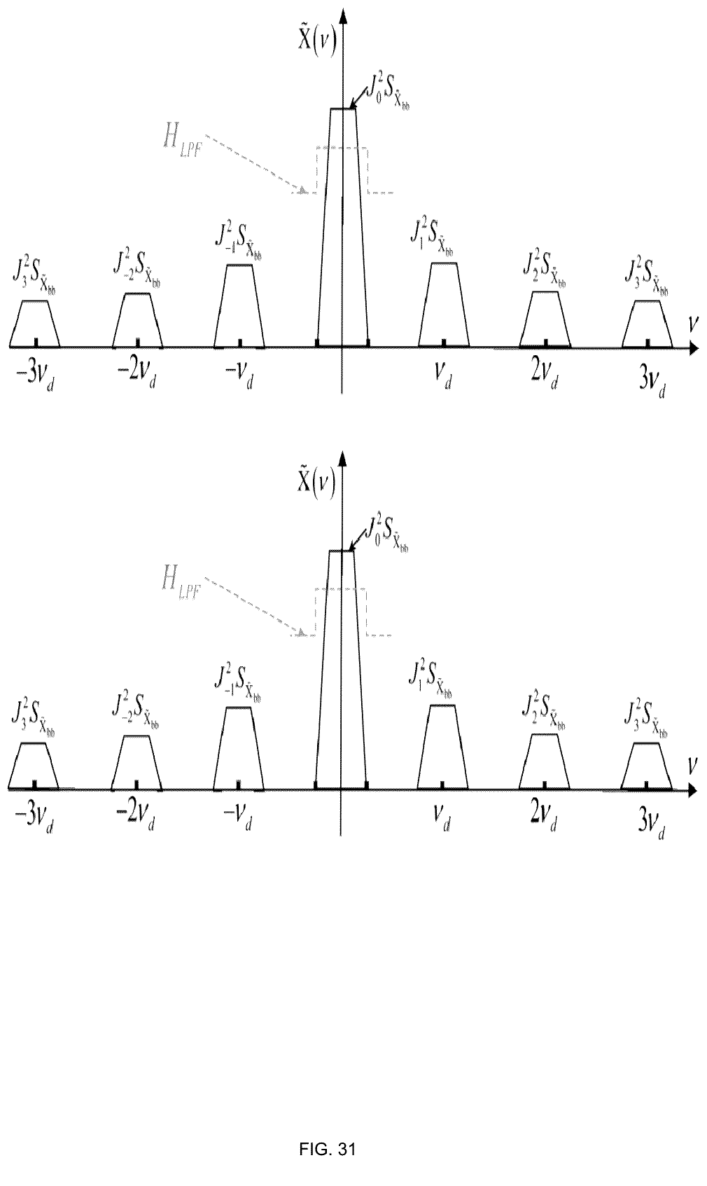

We disclose a family of embodiments (FIG. 29) referred to as preModulated Quadrature-Resonant-Self-Heterodyne (preMOD QRSH) interferometers, wherein the optical system in the s-path consists of a resonator, whereas the r-path is an optical delay line. This embodiment belongs to our general class of OFS systems with two decoupled s- and r-paths, with the r-path consisting of an optical delay line and the s-path being the cascade of one or two optical delay lines and a frequency-selective system. In this embodiment the frequency-selective system in the s-path is a resonator. If there are two optical delay lines in the s-path then they are on either side of the resonator. Part (a) of FIG. 29 depicts the generic block diagram. Parts (b) and (c) describe two of the possible implementation options of this embodiment, integrated photonic

Micro-Ring-Resonator (MRR), discrete-optics Fabri-Perot (FP) cavity in reflection. Fiber based resonators (recirculating delay lines, not depicted in the figure) may also be considered. All resonator types of systems may have their transfer functions represented in a unified way as described in the mathematical modeling preamble section.

In its locked mode, the instant optical frequency is hovering around an anti-resonant operating point where there is a notch of the spectral response (transmission TF for the MRR, reflection TF for the FP cavity). The resonator, be it an FP or MRR is preferably designed to be able to operate in its critically coupled mode, i.e. the anti-resonant notch is actually a null of reflection for the FP cavity and a null of transmission for the MRR. This simplifies the analysis but also yields optimal performance. The resonator in the disclosed embodiment need not be operating in the critically coupled (CCP) mode but the modeling for this embodiment (i.e., a non-perfect notch is allowed as long as there is a minimum of transmission). It turns out that a resonator that is not quite in the critically-coupled regime has the same essential features as that in the critically coupled case, thus it suffices to model the critically coupled resonator.

This embodiment breaks out into several embodiments depending on the type of the dual-output dithering modulator. The analytical modeling presented below pertains to the embodiment of Phase Modulator (PM), but the treatment of the Amplitude Modulator realized as push-pull MZM, and the IQ modulator is quite similar, just having different Fourier coefficients, psy, ph for the modulation transfer factors for the s- and r-paths. The common feature of the pertinent Fourier coefficients in all these three modulation options that the Fourier coefficients be all real-valued.

### Resonator-Based (preMOD QRSH) Modeling

We now mathematically model having the resonator in the s-path while using the r-path as coherent reference (self-coherent effective local oscillator) showing that it yields OFS functionality. For a resonator based system using the PM, followed by a 1:2 splitter the modulation Fourier coefficients are given by

$${μ}_{n}^{s} = {μ}_{n}^{r} = \frac{1}{2} {J}_{n} ( β ) ,$$

and the two modulation transfer factors to the two split ports are:

$${M}_{MOD}^{s} ( t ) = {M}_{MOD}^{r} ( t ) = \frac{1}{\sqrt{2}} {M}_{PM} ( t ) = \frac{1}{\sqrt{2}} {\sum }_{n = - ∞}^{∞} {J}_{n} ( β ) {e}^{j n {ω}_{d} t} \qquad ( 10 )$$

The derivation for our disclosed resonator based OFS system may simply specialize the generic model described above, which assumed an r-path consisting of an optical delay line and an s-path consisting of the cascade of an optical delay line and a generic frequency-selective system, which in the case at hand consists of the resonator.

### Adjustable Offset Sideband Locking of Tunable Laser to a Nulling Frequency of the preMOD QDSH

We now disclose that it possible to replace the preMOD QRSH OFS by a preMOD QDSH OFS, for the purpose of sideband offset locking of the laser, i.e., the resonator may be now replaced by a delay interferometer (DI), and the laser offset locking is with respect to a minimum of the DI response. The idea is to utilize the nulling frequency grid as reference points for offset nulling.

Recalling (4) the nulling frequencies, at which the heterodyne response nulls out (all the harmonic subcarriers vanish) are given by ν_{d}^{null}=m·ν_{FSR}, m∈ [symbol] . Even prior to offset nulling we could lock a tunable laser at zero offset relative to the one of the points of the nulling frequencies grid , by sensing the absolute value of the heterodyne response and setting up a servo loop to null out this absolute value by actuating increments to the tuning frequency control of the laser. This sub-system is going to be described as ‘on-carrier locking of tunable laser to a QDSH nulling frequency’.

This works all the same for a sideband of the tunable laser (provided it is initially close to one of the nulling frequencies, such that the loop locks onto that particular sideband. This sub-system is going to be described as ‘sideband offset locking of tunable laser to a QDSH nulling frequency’.

But the two lasers are identical in terms of hardware, just their initialization is different. Thus, the two variants together are referred to as ‘on-carrier or sideband offset locking of tunable laser to a QDSH nulling frequency’.

The structure of the sensor providing the estimate of the separation between the nulling frequency and the sideband to be locked to it, (FIG. 25) for adjustment of the dither frequency in order to track the fluctuations of the DGD. Except that now no feedback is provided to the dither frequency. The feedback is rather provided to the laser frequency to be adjusted into sideband offset locking to the nulling frequency. The nulling frequency is now used as reference for the sideband offset-locking. The overall laser offset sideband locking tuner subsystem, including its signal processing is shown in FIG. 9. Such signal processing module may be readily added to the signal processing block diagram, fed by the first harmonic MRC output.

### Optical-Mutual-Frequency-Sensor (OMFS)—for Offset-Locking Two Independent Beams

Our disclosed system, referred to as ‘Optical Mutual Frequency Sensor’ (OMFS) may be viewed as a generalization of our disclosed OFS. The OMFS (FIG. 10) features a pair of optical inputs, in contrast to the single optical input into our OFS, and a single optical input. The OMFS basic functionality is to sense the mutual frequency deviations (FD) of the input pair of optical sources.

By ‘Mutual FD’ we mean the difference of the FDs of the two optical sources (with both FDs measured relative to some common reference frequency). In this sense, our OMFS is a sub- system within a complete closed loop feedback control system intended to lock two optical sources together. Availability of an improved Mutual FD measurement enables tuning at least one of the two sources at prescribed frequency separation from the other, assisted by the synthesizer closed loop technique taught by Nikas et al, provided that at least one of the two laser sources is tunable in frequency.

In FIG. 10 we briefly outline the optical front-end of an embodiment of the photonic layout of a photonic synthesizer system, for tunable, electrical tone generation to the sub-THz range, based on our disclosed OMFS, augmented by an electrical PLL. Based on our disclosed OMFS as the core subsystem, this photonic synthesizer heterodyne-locks two CW lasers (at arbitrarily programmable spectral separation, say over the sub-THz spectral range, outputs the two precision-frequency-offset beams on a pair of optical outputs, and also outputs, on a third output port, the optical superposition of the two locked beams, such that when this optical output ports feeds an ultra-fast PD, then an ultra-spectrally pure heterodyne electrical beat tone is synthesized.

As shown in FIG. 10 the synthesizer-based controller for closed-loop locking of two sources is considered external to our OMFS system, and we do not claim it. The synthesizer is intended to accurately tune the modulation drive tones to desired values, such as to control the mutual shift of the two comb of harmonics created by the two PMs, which implies that one or both lasers be tuned to generate the constraint imposed by the synthesizer onto the distance between a ‘tooth’ of one of the PM-comb and another ‘tooth of the other PM-comb.

The two unmodulated light sources, which are mutually tuned with precision, may then be directed to be coupled by a single-quadrature hybrid or in a 2:1 splitter feeding a single ended photodiode, in order to generate an RF or sub-THz beat tone at high spectral purity and with tone frequency tunability (provided that at least one of the light sources is endowed with coarse and fine tunability of its FD).

Our disclosed OMFS structure enables tapping the unmodulated light sources in parallel, prior to applying modulations onto the two beams for the purpose of sensing their mutual FD, to direct the two unmodulated light sources to the sub-THz mixing PD. Using two unmodulated beams for sub-THz mixing improves the quality of the generated sub-THz tone considerably, as it is not interfered by spurious signals as arising in the Nikas et al scheme.

Moreover, we adopted the dual-quadrature-Hybrid (IQH), for the first time to the tasks of mixing two lasers together.

In a nutshell, the structure and the principle of operation of the OMFS (and the closed loop dual-laser control system that may be based on it) are as follows: modulation sidebands are convolved around the optical carriers of both lasers, by means of a Dual Input Dual Output (DIDO) modulator consisting of a pair of phase modulators (PM) in parallel (other structures for the DIDO modulator are possible, e.g. a pair of MZMs). The s- and r-optical signals then feature line spectra. In the single or dual-quadrature optical hybrid provided in the OMFS, the modulated subcarriers of the s- signal beat together with the modulated subcarriers of the r-signal generating in the PD-pair(s) of the hybrid harmonic beats, all of which are modulated by a common baseband random signal to be sensed, having the Mutual FD information of the two lasers (the difference of their individual FD random processes) encoded onto it as random FM modulation.

This is similar to how the optical hybrid of the preMOD QDSH OFS mixes the s- and r-signals, which are split there from a single optical source over the two paths of the DI, which also carry line spectra, whereas in the OMFS the optical sources of the s- and r-signals are independent, thus the redundant common information modulated onto the electrical beats carries mutual FD information (jointly describing the two lasers. In the OFS case, the electrical beats generated in the hybrid all carry redundant common FD information from a single optical source. These considerations suggest that the signal processing techniques disclosed for extracting and processing the common information modulated on the optical beats of the OFS are amenable to being ported for extracting and processing the common information modulated onto the optical beats of the OMFS.

Operationally, the OMFS functionality includes generation of ultra-pure (low-phase noise) tunable electrical tones at ultra-high frequency.

Note: the generation of sub-THz tone(s) in this description may be supplanted by generation of pure RF tone(s) at lower RF frequencies, e.g., in the UHF band.

The simplest use case of the disclosed OMFS is for mutually characterizing, in open loop, a pair of input laser beams which are relatively offset in their optical carrier frequencies. A higher-level use case for the OMFS is to act as the sensor element in a closed loop, ‘locking’ the two lasers together, i.e. maintaining them at fixed spectral separation, for the purpose of generating a stable low phase noise beat tone, by mixing them onto a fast PD to generate the high-frequency pure beat tone.

Our system provides more freedom to shape the line optical spectra (by means of using a DIDO modulator) and by providing access to the pair of unmodulated optical sources, to be tapped for optical beating such that a sub-THz single tone is generated in the heterodyne mixing process (the photo-detection means for optical beating generation of the sub-THz tone is different than the photo-detection means in the optical hybrid).

Our system is referred to as OMFS, since it extracts the ‘mutual frequency deviation’ (mutual FD) of the two laser sources, i.e., the difference of the optical instantaneous frequencies of the complex-envelopes of two beams) as well as extracting their ‘mutual FD wander’ (i.e., the moving-average of the difference of their optical carrier frequencies), with ‘mutual’ referring to the aforementioned differences of frequencies of the two lasers. This is to be contrasted with our OFS embodiments, wherein we rather extract the FD of a single input beam into the OFS (with the FD referenced with respect to a characteristic frequency of the optical interferometric structure).

In detail, the unique aspects of our OMFS disclosure, are:
(a) our usage of a pair of independent optical input sources (at least one of which is tunable in optical frequency).
(b) our usage of a pair of optical modulators in parallel (each respectively modulating one of the two optical input sources mentioned above). Particular embodiments for the two modulators disclosed in our OMFS are phase modulators (PM).
(c) We provision a either a single-quadrature or dual-quadrature hybrid (IQH) for the purpose of sensing the optical spectral structure. This yields improved synthesized output specs, and increase the robustness of phase-detection. The usage of the optical hybrid, especially the dual-quadrature one for sensing the mutual FD information provides improved sensing performance.

We also disclose performing the beating of the two lasers by means of a single-quadrature hybrid (a 2:2 port followed by a balanced-PD-pair, which is more effective than the conventional approach of combining two lasers via a 2:1 port terminated in a single-ended-PD.

The mutual FD of the two sources is more accurately and robustly estimated by our disclosed signal processing acting on the outputs of the provisioned single-quadrature or dual-quadrature hybrid. This signal processing sharing considerably algorithmic commonality with our signal processing disclosed heretofore for the OFS.
(d) The OMFS is a subsystem in a full-solution. It may be extended to an alternative full-solution for an opto-electronic synthesizer by using the K/M frequency divider, the mixer and the loop filter and RF VCO.
(e) Having disclosed in point (c) above the usage of a single- or dual-quadrature hybrid, we further disclose reusing most of our post-detection signal processing methods originally disclosed in this document for our OFS, for processing the output dual-quadrature hybrid (IQH) of the OMFS disclosed here, namely reusing the signal processing which we disclosed in FIG. 6, with evident modifications of having the two input beams into the optical hybrid now at different frequencies rather than at a common optical frequency as in the OFS.

Note that compared to our OFS, our disclosed OMFS opto-electronic front (FIG. 10) is even simpler, as the OFS dual-track interferometric structure is absent in the OMFS—all that is needed here is to pre-modulate the two input beams in the Dual-Input-Dual-Output (DIDO) optical pre-modulator ahead of our disclosed single- or dual-quadrature hybrid, and have the two pre-modulated beams directly passed to the two input ports of the single- or dual-quadrature hybrid.

Thus, as depicted in FIG. 10, the two incoming beams into the OMFS (typically CW beams but may also be carrying optical combs for additional harmonic structuring) are passed through the DIDO optical modulator with dual-inputs and dual-modulated-outputs. The two modulated outputs of the DIDO optical modulator are then directly passed to the pair of inputs of a single- or dual-quadrature hybrid.

In the simplest case the DIDO optical modulator consists of two PM modulators in parallel.

In case that our adopted hybrid is of the single-quadrature type, then the post-detection signal processing section may make uses of analog and/or signal processing techniques as disclosed in the block diagrams of FIGS. 6 and 7. First, the lowest frequency beat tones (or single dominant beat tone in a special case) are demodulated in our earlier disclosed parallel multitone complex DEMOD bank.

Next, no matter whether the hybrid is a single- or a dual-quadrature one, the signal processing to follow is quite similar: we may reuse the IQI-comp (estimation and mitigation of the IQ-imbalance of the optical hybrid and joint estimation of the arrival phases (which are passed to the demodulation bank for optimal performance) and perform analog or digital coherent combining in the Maximal Ratio Combining (MRC) module, extracting from the redundant multiple demodulated signals am improvement of the signal-to-noise ratio. Note: IQ imbalance may also arise when a single quadrature hybrid is used—the source of IQ imbalance is not the optical hybrid (as it is assumed to have a single quadrature) but it is now the IQ-demodulator following the single-quadrature hybrid (especially if this IQ demod is implemented in analog electronics.

Next, in the FD&RIN est module, we perform decoupled extraction of the mutual-FD fluctuations having it separated from the Relative-Intensity-Noise (RIN)-induced field amplitude fluctuations (note: the extraction of the RIN-term optional in some laser characterization systems, while it is not generally necessary in laser stabilization/locking systems). The separation of the FD and RIN terms is preceded by estimation-and-compensation of the low-frequency differential phase wander between the s- and r-paths, which may be realized by means of the PLL disclosed for the OFS.

To we leverage new ingredients: a pair of input beams; a pair of PMs, a single-quadrature or dual-quadrature hybrid and the suite of our signal processing modules disclosed in our OFS signal processing, most of which are re-used for the OMFS (it is only the ‘DGD/FSR est’ module that is not used here, as there is no DI in the OMFS, therefore no DGD to estimate). The OMFS is merely the sensor sub-system of a complete closed loop optical synthesizer, which could use our disclosed OMFS as a subsystem with the electronic controller (the PLL processing).

To elaborate, a low-linewidth laser acts as the master optical oscillator while a second slave laser is locked via an OPLL to a precisely defined optical frequency relative to the master. For the purpose of locking the two lasers, harmonic combs are generated in the DIDO modulator by phase modulating each of the CW lasers tapped outputs with multitone (or in particular sinusoidal) reference frequencies. The multitone signals may have either identical or different fundamental frequencies, denoted ν_{d}^{s}, ν_{d}^{r} (in case the fundamental frequencies of the two modulator drives are different, ν_{d}^{s}≠ν_{d}^{r} they are taken commensurate, e.g., as may be generated by an electronic synthesizer, such as the one used for the closed loop controller in FIG. 10. In other embodiments we will take ν_{d}^{s}=ν_{d}^{r}≅ν_{d}, i.e., the two lasers are modulated by their respective PMs at the same dither frequency, ν_{d}).

The two phase-modulated beams from the r-laser and s-laser are passed into the I and Q inputs of the dual-quadrature hybrid. The frequency offset between the two lasers is then precisely set based on the frequency divider in the electronic PLL. The electrical output of the OPLL is used to drive the frequency controls of the s-laser (which may be considered a ‘slave’ to the master reference r-laser). The PLL electronic controller structure and its analysis are elaborated in T. Nikas, E. Pikasis, A. Bogris, and D. Syvridis, “A Microwave Optoelectronic PLL Synthesizer Based on Optical Comb Reference,” IEEE Photonics Technol. Lett., vol. 31, no. 8, pp. 623-626, Apr. 2019, doi: 10.1109/LPT.2019.290187. When the PLL loop is locked, the phase (and frequency) noise fluctuations of the slave laser nearly track those of the master r-laser (within the loop bandwidth). In effect, the loop causes the phase (and its derivative, the instant FD) of the s-laser to track that of the r-laser, i.e., the difference of their phases (and its derivative, the mutual-FD) are suppressed.

Thus, if the r-laser is an ultra-low-linewidth laser, the s-laser laser effectively tracks it (even if it has higher phase noise, i.e. worse linewidth, though the amount of suppression will be lower), such that the beat signal generated between the two lasers is narrowband, approaching the level of the r-laser linewidth. Thus, the beat tone between the two unmodulated lasers is a very pure sinusoidal electrical tone, virtually free of phase noise and spurious harmonics. Moreover, the two optical CW outputs may be mutually locked at arbitrarily specified spectral offset.

We note that the mixing of the two tapped CW lasers for the purpose of the pure ‘sub-THz’ electrical tone generation, is performed in our system block diagram by a single-quadrature hybrid (which is separate from the single-quadrature or dual-quadrature hybrid used for the mutual FD measurement of the OMFS). We also disclose replacing this single-quadrature hybrid, used for the sub-THz generation, by a simple combiner+single-ended PD. However, the usage of the single quadrature hybrid for the optical beating generating the sub-THz pure tone is our preferred embodiment, as it improves the generated sub-THz signal amplitude by a factor-of-two while also improving by 3 dB the SNR due to independent noises on the two beating optical signals.

### OMFS Assisted Offset-Sideband-Locking of Two Lasers to a Resonator Mode

Yet another laser tuning system is disclosed in FIG. 11, for tunable offset sideband locking of a pair of lasers, assisted by an optical resonator, albeit with a pair of lasers, using the OMFS mutual FD sensing capability (rather than with a single laser as seen in FIG. 9, assisted by the OFS). The objective is to have the two lasers have their optical frequencies at prescribed, adjustable mutual spectral separation, such as to generate a spectrally pure yet tunable electrical beat frequency, but in addition to have the capability of precision-tuning the two absolute optical frequencies (while retaining their prescribed mutual spectral separation). One possible application of this capability would be optical network analysis.

To this end, an optical resonator is inserted into the s-path of the OMFS of FIG. 10, and the signal processing is adapted to provide the loop filtering functionality, in order to close the loop on the s-laser tunable frequency, having it locked at continually variable spectral offset away from a mode of the resonator, by having an FLL capture one of its sidebands into an anti-resonant notch of that mode of the resonator, so as to stabilize it. The variable offset is attained by tuning the s-path PM dither frequency to change the sidebands spectral spacing, and simultaneously coarse-tuning+fine tuning the s-laser frequency in unison, maintaining the sideband at the minimum the relatively stable resonator spectral notch, considered as frequency reference. A coarse scan of the s-laser optical frequency and/or the r-path PM dither frequency initializes the FLL capture of the sideband into lock within the resonator notch.

Moreover, whereas the s-laser is tuned at variable offset relative to the anti-resonant frequency, as described above, the r-laser is locked at prescribed offset away from the s-laser, according to the principle of operation of the OMFS as a sensor of the mutual FD between the two lasers using a synthesizer-based PLL, external to the OMFS, as overviewed in (v-e) above. This yields adjustable prescribed tuning of the spectral spacing between the s- and r-lasers (by tuning the sideband combs of the two PMs while the r-laser frequency is tuned). In this embodiment, not only is the sub-THz beat tone accurate and tunable in frequency (as set by means of the synthesizer) but the two optical frequencies are relatively accurately set in absolute terms, since the s-laser is sideband-locked to a resonant mode (an anti-resonant frequency) of the passive resonator in the s-path, whereas the r-laser is tuned at prescribed offset away from the s-laser (using the OMFS principle). The spectral stability of the resonator is then transferred to both the s-laser and to the r-laser, while the spectral separations are adjustable.

The embodiment just disclosed here (FIG. 11) is then a combination of the OMFS embodiment described above (FIG. 10) and the embodiment (FIG. 9) for tunable locking of a laser (here the r-laser) to a cavity anti-resonance by means of applying PM sidebands to it and actually locking one of the sidebands, say the dominant one, to one of the modes of the inserted passive resonator.

According to one or more embodiments there is provided an optical frequency sensor that includes (i) a heterodyne modulation and splitting unit that is configured to receive a first laser signal, modulate the first laser signal to provide a modulated laser signal and split the modulated laser signal to provide pre-processed optical signals; (ii) a self-coherent interferometer that includes : (ii.1) a first optical processor that is configured to process the pre-processed optical signals to provide processed optical signals; and (ii.2) a detection unit that is configured to electro-optically mix the processed optical signals and photodetect an outcome of the mixing to provide detection signals; and (iii) a signal processor configured to process the one or more digital signals to provide digital information about the first laser signal.

Examples of an optical frequency sensor (also referred to as OFS, resonator-based OFS, DI based OFS) are provided in FIG. 1 setcion (a), FIGS. 2-5, FIGS. 10-11, FIGS. 25-26, FIG. 28 sections (a)-(b), and FIG. 29 sections (a)-(c).

FIG. 9 sections (a)-(b) illustrates the OFS used to lock a frequency of a laser—as part of as a OFD-based sideband-offset laser locking.

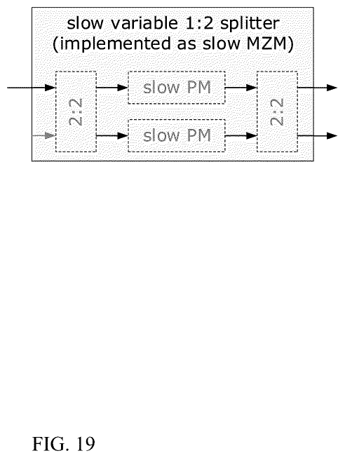

Examples of a heterodyne modulation and splitting unit (also referred to as IDT) are illustrated in FIG. 1 setcions (a)-(b), FIGS. 2-5, FIGS. 10-11, FIG. 19, FIGS. 25-26, FIG. 27 sections (a)-(b), FIG. 28 sections (a)-(b), and FIG. 29 sections (a)-(c).

Examples of a detection unit (also referred to as optical hybrid or single header combiner) are illustrated in FIG. 1 setcions (a) and (c), FIGS. 2-3, FIG. 9 sections (a)-(b), FIGS. 10-11, FIGS. 25-26, FIG. 28 sections (a)-(b), and FIG. 29 sections (a)-(c).

Examples of a signal processor are illustrated in FIG. 1 setcion (a), FIG. 3, FIGS. 6-7, FIG. 9 sections (a)-(b), FIGS. 10-11, FIGS. 25-26, FIG. 28 sections (a)-(b), and FIG. 29 sections (a)-(c).

Examples of pre-processed optical signals are variants of E_{d}(t)—such as E_{d}^{top}(t), E_{d}^{bot}(t), E_{d}^{r}(t), E_{d}^{s}(t).

Examples of processed optical signals are Es and Er or versions of these signals (see for example FIG. 13).

Examples of detection signals are I(t) and Q(t) or versions of these signals.

According to an embodiment, the heterodyne modulation and splitting unit is configured to modulate the first laser signal using a initial modulation signal of an initial frequency. Examples of initial modulations signals are +Vd(t) and −Vd(t) in FIG. 1 section (b), 8

According to an embodiment, the first optical processor includes an additional modulator that is configured to modulate a first pre-processed optical signal to provide a first processed optical signal, using an additional modulation signal of an additional frequency that is lower (by at least a factor of 2, 3, 4, 5, 6, 7, and even more) than the initial frequency. See, for example the “slow” phase modulator or “slow” amplitude modulators” of FIG. 5.

According to an embodiment, the first optical processor includes additional modulators that are configured to modulate a first pre-processed optical signal and a second pre-processed optical signals to provide a first processed optical signal and a second processed optical signals, respectively, using an additional modulation signal of an additional frequency that is lower (by at least a factor of 2, 3, 4, 5, 6, 7, and even more) than the initial frequency. See, for example the two “slow” phase modulator or two “slow” amplitude modulators” of FIG. 5.

According to an embodiment, the optical frequency sensor further includes a additional modulation signal generator that is configured to determine a value of the additional modulation signal based on a demodulated output of the detection unit, and a dither signal. See, for example the demodulator (slow DMOD) of FIG. 5.

According to an embodiment, the optical frequency sensor further includes an additional modulation signal generator that is configured to apply a dithering extremum seeking control scheme. See, for example the feedback loop that includes ES controller of FIG. 5.

According to an embodiment, the first optical processor is configured to electro-optically mix the pre-processed optical signals to provide the processed optical signals. See, for example generic DIDO of FIG. 1 section (c).

According to an embodiment, the first optical processor is configured to process the pre-processed optical signals without mixing the pre-processed optical signals to provide the processed optical signals. See, for example, other IDT units of FIG. 1 section (c), in FIG. 13.

According to an embodiment, the first optical processor includes a first processing path for processing a first pre-processed optical signal and a second processing path for processing a second pre-processed optical signal. The dual paths are illustrated in FIG. 1 setcions (a)-(b), FIGS. 2-5, FIGS. 10-11, FIG. 19, FIGS. 25-26, FIG. 27 sections (a)-(b), FIG. 28 sections (a)-(b), and FIG. 29 sections (a)-(c).

According to an embodiment, the first processing path includes a resonator and the second processing path includes a delay unit.

According to an embodiment, the first processing path includes a first delay unit that introduced a first delay, and the second processing path includes a second delay unit that introduced a second delay.

According to an embodiment, the first processing path is associated with a delay having a value that is not associated with the second processing path. Thus—only one of the processing paths has a delay unit or the processing paths have delay units that introduce different delays.

According to an embodiment, the first processing path includes a first resonator and the second processing path includes a second resonator.

According to an embodiment, the optical frequency sensor , wherein the detection unit is a single ended combiner. See, for example FIG. 12, section (a).

According to an embodiment, the detection unit is a single quadrature hybrid unit. See, for example FIG. 12, section (b).

According to an embodiment, the detection unit is a dual quadrature hybrid unit. See, for example FIG. 12, section (c).

According to an embodiment, the heterodyne modulation and splitting unit includes a push-pull dual-output Mach-Zehnder modulator. See, for example FIG. 26 sections (a)-(c).

According to an embodiment, the detection unit is a dual quadrature hybrid unit, wherein the detection signals are a first and a second detection signals, wherein the processed signals are a first and second processed signals, wherein signal processor includes a demodulation bank (DEMOD bank), and a compensation unit (joint phase recovery and IQcomp), a combiner (MRC diversity combiner) and one or more analysis units (RIN & FD est, GDR/FSR est. module, Upper layer signal processing/LOOP FILTERING). See, for example, FIG. 6.

According to an embodiment, the demodulation bank is configured to receive the first and second detection signals, and extract complex harmonic subcarriers of the first and second detection signals. In FIG. 6 there is a compensation unit per each complex harmonic subcarrier.

See also FIG. 18. 6

According to an embodiment, the compensation unit is configured to (a) estimate, per complex harmonic subcarrier, (i) the quadrature components imbalance and (ii) phase mismatches between the demodulation bank and the dual output heterodyne modulator, and (b) compensate for the quadrature components imbalance and for phase mismatches to provide compensated signals per complex harmonic subcarrier. These estimations are executed, for example by IQI comp bank and WL clippse est.

According to an embodiment, the combiner is configured to combine compensated signals of the same detection signal of the first and second detection signals.

According to an embodiment, the one or more analysis units are configured to perform at least one of frequency deviation (FD) analysis, relative intensity noise (RIN) analysis, differential group delay (DGD) analysis, or free spectral range (FSR) analysis.

According to an embodiment, at least a part of the signal processor operates in a digital domain.

According to an embodiment, at least a part of the signal processor operates in an analog domain.

There is provided a method for operating any of the optical frequency sensors illustrated in the application.

FIG. 14 illustrates an example of method 1400 for operating an optical frequency sensor, the method includes: (i) step 1410 of receiving, by a heterodyne modulation and splitting unit, a first laser signal; (ii) step 1420 of modulating, by the heterodyne modulation and splitting unit, the first laser signal to provide a modulated laser signal; (iii) step 1430 of splitting, by the heterodyne modulation and splitting unit, the modulated laser signal to provide pre-processed optical signals; (iv) step 1440 of processing, by a first optical processor of a self-coherent interferometer, the pre-processed optical signals to provide processed optical signals; (v) step 1450 of electrooptically mixing, by a detection unit of the self-coherent interferometer, the processed optical signals; (vi) step 1460 of photodetecting, by the detection unit, an outcome of the mixing to provide detection signals; and (vii) step 1470 of signal processing, by a signal processor, the one or more digital signals to provide digital information about the first laser signal.

There is provided a signal processor that includes (i) a demodulation bank (DEMOD bank) configured to: (a) receive a first and a second detection signals from a dual quadrature optical hybrid unit, wherein there is an quadrature components imbalance between the first and second detection signals; the dual quadrature optical hybrid unit was fed with a first processed optical signal and a second processed optical signal, the processed optical signals being indicative of a first laser signal that was modulated by a dual output heterodyne modulator that preceded a self-coherent interferometer that includes the dual quadrature optical hybrid unit; and (b) extract complex harmonic subcarriers of the first and second detection signals; (ii) a compensation unit (joint phase recovery and IQcomp) configured to (a) estimate, per complex harmonic subcarrier, the quadrature components imbalance and phase mismatches between the demodulation bank and the dual output heterodyne modulator, and (b) compensate for the quadrature components imbalance and for phase mismatches to provide compensated signals per complex harmonic subcarrier; (iii) a combiner (MRC diversity combiner) configured to combine compensated signals of the same detection signal of the first and second detection signals; and (iv) one or more analysis units (RIN & FD est, GDR/FSR est. module, Upper layer signal processing/LOOP FILTERING) that are configured to analyze parameters of the first laser signal. An example of the signal processor is provided in FIG. 6.

According to an embodiment, any reference to an analysts unit that is configured to determine a parameter of a laser signals should be applied mutatis mutandis to an analysis unit configured to determine a parameter of the OFS and/or of an optical processor (for example physical lengts of at least one processing path of the first optical processor and/ delay difference between processing paths of the first optical processor).

According to an embodiment, at least a part of the signal processor operates in a digital domain.

According to an embodiment, at least a part of the signal processor operates in an analog domain. An analog domain may include the optical domain and/or an electrical optical domain.

According to an embodiment, the one or more analysis units are configured to perform at least one of frequency deviation (FD) analysis, relative intensity noise (RIN) analysis, differential group delay (DGD) analysis, or free spectral range (FSR) analysis.

There is provided a method for operating any signal processor illustrated above that is configured to recieve and process a first and second detection signals.

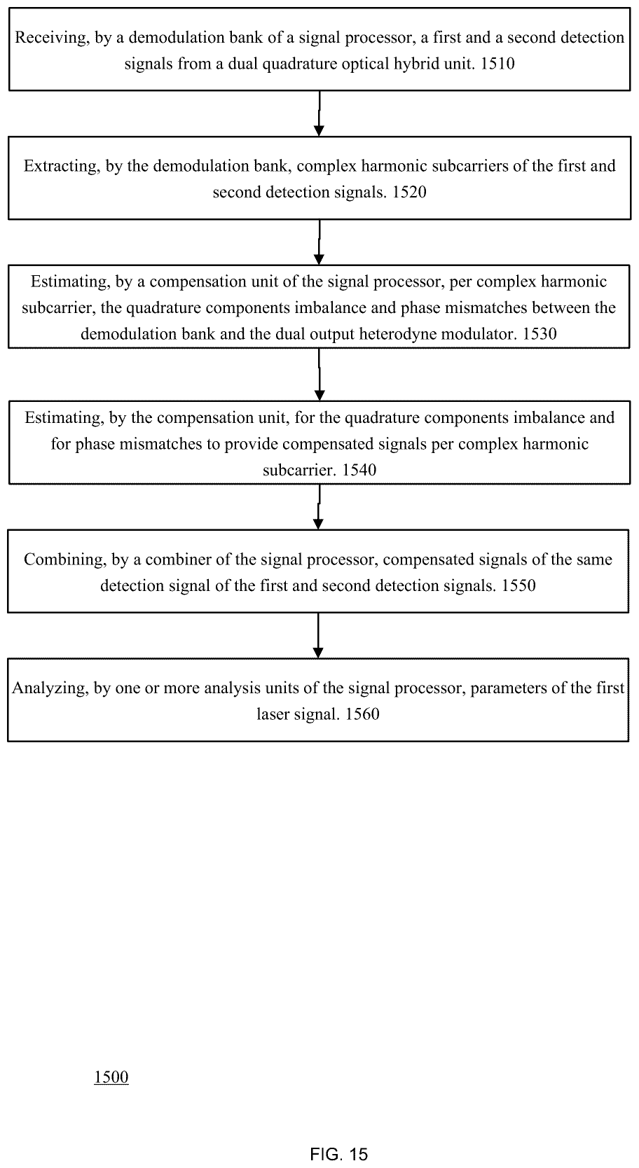

FIG. 15 is an example of a method 1500 for signal processing, the method includes: (i) step 1510 of receiving, by a demodulation bank of a signal processor, a first and a second detection signals from a dual quadrature optical hybrid unit, wherein there is an quadrature components imbalance between the first and second detection signals; the dual quadrature optical hybrid unit was fed with a first processed optical signal and a second processed optical signal, the processed optical signals being indicative of a first laser signal that was modulated by a dual output heterodyne modulator that preceded a self-coherent interferometer that includes the dual quadrature optical hybrid unit; (ii) step 1520 of extracting, by the demodulation bank, complex harmonic subcarriers of the first and second detection signals; (iii) step 1530 of estimating, by a compensation unit of the signal processor, per complex harmonic subcarrier, the quadrature components imbalance and phase mismatches between the demodulation bank and the dual output heterodyne modulator; (iv) step 1540 of estimating, by the compensation unit, for the quadrature components imbalance and for phase mismatches to provide compensated signals per complex harmonic subcarrier; (iv) step 1550 of combining, by a combiner of the signal processor, compensated signals of the same detection signal of the first and second detection signals; and (v) step 1560 of analyzing, by one or more analysis units of the signal processor, parameters of the first laser signal.

According to an embodiment, the at least a part of the signal processing is executed in a digital domain.

According to an embodiment, the at least a part of the signal processing is executed in an analog domain.

According to an embodiment, the analyzing includes at least one of frequency deviation (FD) analysis, relative intensity noise (RIN) analysis, differential group delay (DGD) analysis, or free spectral range (FSR) analysis.

There is provided a signal processor that includes (i) a demodulation bank (DEMOD bank) configured to: (a) receive a first detection signal from a detection unit that is configured to electro-optically mix the processed optical signals and photodetect an outcome of the mixing to provide detection signals the detection unit was fed with a first processed optical signal and a second processed optical signal, the processed optical signals being indicative of a first laser signal that was modulated by a dual output heterodyne modulator that preceded a self-coherent interferometer that includes the detection unit; and (b) extract complex harmonic subcarriers of the first detection signal; the complex harmonic subcarriers includes first complex harmonic subcarriers and second complex harmonic subcarriers; (ii) a compensation unit (includes DEROT bank, MRC diversity orders, subtractor, multiplier, WL ellipse comp and WL elippse comp) configured to (a) estimate, per complex harmonic subcarrier, the quadrature components imbalance associated with the first complex harmonic subcarriers and with the second complex harmonic subcarriers; and (b) compensate for the quadrature components imbalance associated with the first complex harmonic subcarriers and with the second complex harmonic subcarriers to provide compensated signals; and (iii) one or more analysis units (RIN & FD est, GDR/FSR est. module, Upper layer signal processing/LOOP FILTERING) that are configured to analyze parameters of the first laser signal. An example of this signal processor is illustrated in FIG. 7.

In FIG. 7 the DEMOD bank outputs the first and second complex harmonic sub-carrieres. A reference to the first complex harmonic sub-carrier refers to the first positive harmonic sub-carrier and the first negative harmonic sub-carrier that are closest to the carrier frequency.

A reference to the second complex harmonic sub-carrier refers to the second positive harmonic sub-carrier and the second negative harmonic sub-carrier that are follow the first positive harmonic sub-carrier and the first negative harmonic sub-carrier. The MRC diversity order outputs at one arm a sum of compensated signals related to the positive and negative first complex harmonic sub-carriers and output at another arm a sum of compensated signals related to the positive and negative second complex harmonic sub-carriers.

According to an embodiment, the first detection signal is an only detection signal generated by the detection unit.

According to an embodiment, the compensation unit is further configured to estimate phase mismatches between the demodulation bank and the dual output heterodyne modulator, and is further configured to compensate for the phase mismatches.

According to an embodiment, at least a part of the signal processor operates in a digital domain.

According to an embodiment, at least a part of the signal processor operates in an analog domain.

According to an embodiment, the one or more analysis units are configured to perform at least one of frequency deviation (FD) analysis, relative intensity noise (RIN) analysis, differential group delay (DGD) analysis, or free spectral range (FSR) analysis.

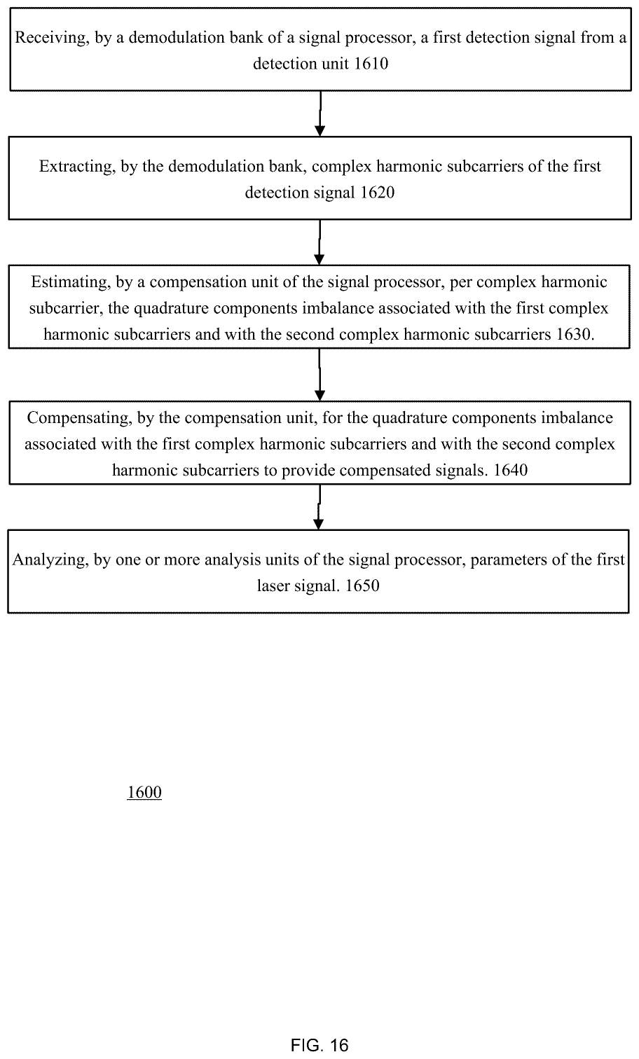

FIG. 16 illustrates an example of method 1600 for signal processing, the method includes (i) step 1610 of receiving, by a demodulation bank of a signal processor, a first detection signal from a detection unit that is configured to electro-optically mix the processed optical signals and photodetect an outcome of the mixing to provide detection signals, the detection unit was fed with a first processed optical signal and a second processed optical signal, the processed optical signals being indicative of a first laser signal that was modulated by a dual output heterodyne 9 modulator that preceded a self-coherent interferometer that includes the detection unit; (ii) step 1620 of extracting, by the demodulation bank, complex harmonic subcarriers of the first detection signal; the complex harmonic subcarriers includes first complex harmonic subcarriers and second complex harmonic subcarriers; (iii) step 1630 of estimating, by a compensation unit of the signal processor, per complex harmonic subcarrier, the quadrature components imbalance associated with the first complex harmonic subcarriers and with the second complex harmonic subcarriers; (iv) step 1640 of compensating, by the compensation unit, for the quadrature components imbalance associated with the first complex harmonic subcarriers and with the second complex harmonic subcarriers to provide compensated signals; and (v) step 1650 of analyzing, by one or more analysis units of the signal processor, parameters of the first laser signal.

According to an embodiment, the first detection signal is an only detection signal generated by the detection unit.

According to an embodiment, step 1630 also include estimating, by the compensation unit, phase mismatches between the demodulation bank and the dual output heterodyne modulator, and step 1640 also include for the phase mismatches.

According to an embodiment, the at least a part of the signal processing is executed in a digital domain.

According to an embodiment, the at least a part of the signal processing is executed in an analog domain.

According to an embodiment, the analyzing includes at least one of frequency deviation (FD) analysis, relative intensity noise (RIN) analysis, differential group delay (DGD) analysis, or free spectral range (FSR) analysis.

There is provided an optical sensor that may be used to lock one laser to another. The optical sensor includes (i) a first optical processor that is configured to (a) receive a first laser signal; (b) modulate, using a first modulating signal, the first laser signal to provide a first modulated laser signal, a spectrum of the first modulated laser signal includes a first carrier frequency and first sub-harmonic frequency subcarrier spectral lines spaced apart as determined by a frequency of the first modulating signal; (c) receive a second laser signal; (d) modulate, using a second modulating signal, the second laser signal to provide a second modulated laser signal, a spectrum of the second modulated laser signal includes a second carrier frequency and second sub-harmonic frequency subcarrier spectral lines spaced apart as determined by a frequency of the second modulating signal; (ii) a signal processor configured to: (a) receive demodulation reference tones, and the first and second modulated laser signals; wherein the demodulation reference tones, the first modulating signal, and the second modulating signal are mutually synchronized; (b) determine a frequency difference between a frequency of a first sub-harmonic frequency subcarrier frequency line and a frequency of a second sub-harmonic frequency subcarrier frequency line; and (c) send control signals to at least one of the first laser or the second laser to set a value of the frequency difference to a defined value. An example of sucha circuit is illustrated in FIGS. 10 and 11. In both figures the first optical processor is a Double input double output (DIDO) modulator (DIDO MOD) that includes a first phse modulator (PM) and a second PM. In FIG. 11 the first optical processor is preceded by an optical resonator.

According to an embodiment, the optical sensor further includes a single hybrid quadrature unit that is configured to receive another part of the first laser signal, receive another part of the second laser signal, electro-optically mix the other part of the first laser signal and the other part of the second laser signal, and to photodetect an outcome of the mixing to provide a detection signal.

According to an embodiment, the signal processor includes a demodulation bank, a com pensation unit, a combiner and one or more analysis units.

According to an embodiment, the optical sensor further includes an optical resonator.

According to an embodiment, the signal processor is configured to send control signals to the first laser and the second laser.

According to an embodiment, the second laser is more accurate that the first laser.

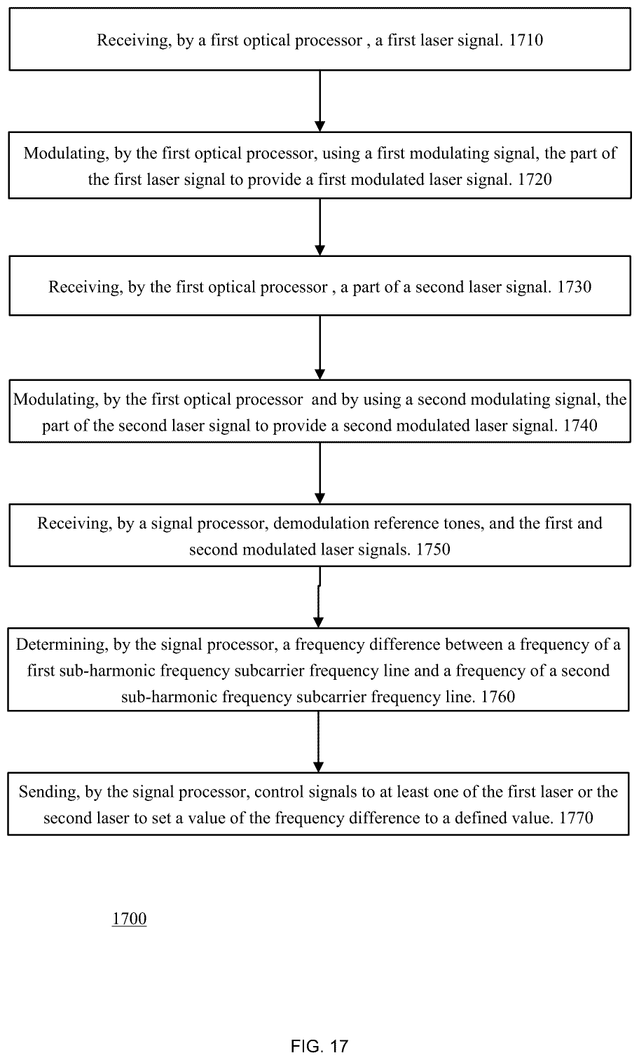

FIG. 17 illustrates a method 1700 for optical sensing, the method includes: (i) step 1710 of receiving, by a first optical processor , a first laser signal; (ii) step 1720 of modulating, by the first optical processor, using a first modulating signal, the part of the first laser signal to provide a first modulated laser signal, a spectrum of the first modulated laser signal includes a first carrier frequency and first sub-harmonic frequency subcarrier spectral lines spaced apart as determined by a frequency of the first modulating signal; (iii) step 1730 of receiving, by the first optical processor , a part of a second laser signal; (iv) step 1740 of modulating, by the first optical processor and by using a second modulating signal, the part of the second laser signal to provide a second modulated laser signal, a spectrum of the second modulated laser signal includes a second carrier frequency and second sub-harmonic frequency subcarrier spectral lines spaced apart as determined by a frequency of the second modulating signal; (v) step 1750 of receiving, by a signal processor, demodulation reference tones, and the first and second modulated laser signals; wherein the demodulation reference tones, the first modulating signal, and the second modulating signal are mutually synchronized; (vi) step 1760 of determining, by the signal processor, a frequency difference between a frequency of a first sub-harmonic frequency subcarrier frequency line and a frequency of a second sub-harmonic frequency subcarrier frequency line; and (v) step 1770 of sending, by the signal processor, control signals to at least one of the first laser or the second laser to set a value of the frequency difference to a defined value.

According to an embodiment, the method includes sending the one or more control signals to the first laser and sensing one or more other control signals to the second laser.

According to an embodiment, the second laser is more accurate that the first laser.

In the foregoing description, numerous specific details are set forth in order to provide a thorough understanding of the solution . However, it will be understood by those skilled in the art that the present solution may be practiced without these specific details. In other instances, well-known methods, procedures, and components have not been described in detail so as not to obscure the present solution.

The subject matter regarded as the solution is particularly pointed out and distinctly claimed in the concluding portion of the specification. The solution , however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present solution may for the most part, be implemented using electronic components and circuits known to those skilled in the art, details will not be explained in any greater extent than that considered necessary as illustrated above, for the understanding and appreciation of the underlying concepts of the present solution and in order not to obfuscate or distract from the teachings of the present solution .

Any reference in the specification to a method should be applied mutatis mutandis to a system capable of executing the method.

Any reference in the specification to a system should be applied mutatis mutandis to a method that may be executed by the system.

In the foregoing specification, the solution has been described with reference to specific examples of embodiments of the solution. It will, however, be evident that various modifications and changes may be made therein without departing from the broader spirit and scope of the solution as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the solution described herein are, for example, capable of operation in other orientations than those illustrated or otherwise described herein.

The connections as discussed herein may be any type of connection suitable to transfer signals from or to the respective nodes, units or devices, for example via intermediate devices.

Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner.

Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components.

Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to solution s containing only one such element, even when the same claim includes the introductory phrases “one or more” or “at least one” and indefinite articles such as “a” or “an.”

The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the solution have been illustrated and described herein, many modifications, substitutions, changes, and equivalents will now occur to those of ordinary skill in the art. It is, therefore, to be understood that the appended claims are intended to cover all such modifications and changes as fall within the true spirit of the solution.

We claim

1. An optical frequency sensor comprising:
a heterodyne modulation and splitting unit that is configured to receive a first laser signal, modulate the first laser signal to provide a modulated laser signal and split the modulated laser signal to provide pre-processed optical signals;
a self-coherent interferometer that comprises:
a first optical processor that is configured to process the pre-processed optical signals to provide processed optical signals; and
a detection unit that is configured to electro-optically mix the processed optical signals and photodetect an outcome of the mixing to provide detection signals; and
a signal processor configured to process the one or more digital signals to provide digital information about the first laser signal.

2. The optical frequency sensor according to claim 1, wherein the heterodyne modulation and splitting unit is configured to modulate the first laser signal using a initial modulation signal of an initial frequency.

3. The optical frequency sensor according to claim 2, wherein the first optical processor comprises an additional modulator that is configured to modulate a first pre-processed optical signal to provide a first processed optical signal, using an additional modulation signal of an additional frequency that is lower by at least a factor of five than the initial frequency.

4. The optical frequency sensor according to claim 2, wherein the first optical processor comprises additional modulators that are configured to modulate a first pre-processed optical signal and a second pre-processed optical signals to provide a first processed optical signal and a second processed optical signals, respectively, using an additional modulation signal of an additional frequency that is lower by at least a factor of five than the initial frequency.

5. The optical frequency sensor according to claim 2, further comprising a additional modulation signal generator that is configured to determine a value of the additional modulation signal based on a demodulated output of the detection unit, and a dither signal.

6. The optical frequency sensor according to claim 2, further comprising an additional modulation signal generator that is configured to apply a dithering extremum seeking control scheme.

7. The optical frequency sensor according to claim 1, wherein the first optical processor is configured to electro-optically mix the pre-processed optical signals to provide the processed optical signals.

8. The optical frequency sensor according to claim 1, wherein the first optical processor is configured to process the pre-processed optical signals without mixing the pre-processed optical signals to provide the processed optical signals.

9. The optical frequency sensor according to claim 1, wherein the first optical processor comprises a first processing path for processing a first pre-processed optical signal and a second processing path for processing a second pre-processed optical signal.

10. The optical frequency sensor according to claim 9, wherein the first processing path comprises a resonator and the second processing path comprises a delay unit.

11. The optical frequency sensor according to claim 9, wherein the first processing path comprises a first delay unit that introduced a first delay, and the second processing path comprises a second delay unit that introduced a second delay.

12. The optical frequency sensor according to claim 9, wherein the first processing path is associated with a delay having a value that is not associated with the second processing path.

13. The optical frequency sensor according to claim 9, wherein the first processing path comprises a first resonator and the second processing path comprises a second resonator.

14. The optical frequency sensor according to claim 1, wherein the detection unit is a single ended combiner.

15. The optical frequency sensor according to claim 1, wherein the detection unit is a single quadrature hybrid unit.

16. The optical frequency sensor according to claim 1, wherein the detection unit is a dual quadrature hybrid unit.

17. The optical frequency sensor according to claim 1, wherein the heterodyne modulation and splitting unit comprises a push-pull dual-output Mach-Zehnder modulator.

18. The optical frequency sensor according to claim 1, wherein the detection unit is a dual quadrature hybrid unit, wherein the detection signals are a first and a second detection signals, wherein the processed signals are a first and second processed signals, wherein signal processor comprises a demodulation bank, and a compensation unit, a combiner and one or more analysis units.

19. The optical frequency sensor according to claim 18, wherein the demodulation bank is configured to receive the first and second detection signals, and extract complex harmonic subcarriers of the first and second detection signals.

20. The optical frequency sensor according to claim 18, wherein the compensation unit is configured to (a) estimate, per complex harmonic subcarrier, (i) the quadrature components imbalance and (ii) phase mismatches between the demodulation bank and the dual output heterodyne modulator, and (b) compensate for the quadrature components imbalance and for phase mismatches to provide compensated signals per complex harmonic subcarrier.

21. The optical frequency sensor according to claim 18, wherein the combiner is configured to combine compensated signals of the same detection signal of the first and second detection signals.

22. The optical frequency sensor according to claim 18, wherein the one or more analysis units are configured to perform at least one of frequency deviation (FD) analysis, relative intensity noise (RIN) analysis, differential group delay (DGD) analysis, or free spectral range (FSR) analysis.

23. The optical frequency sensor according to claim 1, wherein at least a part of the signal processor operates in a digital domain.

24. The optical frequency sensor according to claim 1, wherein at least a part of the signal processor operates in an analog domain.

25. A method for operating an optical frequency sensor, the method comprises:
receiving, by a heterodyne modulation and splitting unit, a first laser signal;
modulating, by the heterodyne modulation and splitting unit, the first laser signal to provide a modulated laser signal;
splitting, by the heterodyne modulation and splitting unit, the modulated laser signal to provide pre-processed optical signals;
processing, by a first optical processor of a self-coherent interferometer, the pre-processed optical signals to provide processed optical signals;
electrooptically mixing, by a detection unit of the self-coherent interferometer, the processed optical signals;
photodetecting, by the detection unit, an outcome of the mixing to provide detection signals; and
signal processing, by a signal processor, the one or more digital signals to provide digital information about the first laser signal.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)
